(19) United States
(12) Patent Application Publication
(10) Pub. No.: US 2026/0213104 A1
(43) Pub. Date: Jul. 23, 2026

(54) FIXED CONTACT PART AND BREAKER INCLUDING SAME

(71) Applicant: LS ELECTRIC CO., LTD., Anyang-si, Gyeonggi-do (KR)

(72) Inventor: Seung Pil YANG, Anyang-si, Gyeonggi-do (KR)

(21) Appl. No.: 19/140,529

(22) PCT Filed: Dec. 21, 2023
(86) PCT No.: PCT/KR2023/021292

§ 371 Date: Jun. 18, 2025

(30) Foreign Application Priority Data
Jan. 3, 2023 (KR) 10-2023-0000639

(51) Int. Cl. H01H 71/02; H01H 71/46

(52) U.S. Cl. CPC H01H 71/0235; H01H 71/46

(57) ABSTRACT

Disclosed are a fixed contact part and a breaker including the same. A fixed contact part according to one aspect of the present disclosure may include: a fixed contact bar conductively connected to an external power source or an external load; a fixed contact coupled to the fixed contact bar and configured to come into contact with a movable contact; and an arc runner positioned at one side of the fixed contact bar based on a height direction and configured to guide a generated arc, in which the fixed contact bar includes: a first extension portion extending in one direction; and a second extension portion continuously connected to the first extension portion while having a predetermined angle with respect to the first extension portion, and in which the arc runner is seated and supported on the second extension portion.

### CROSS-REFERENCE TO RELATED APPLICATIONS

This application is a National Stage of International Application No. PCT/KR2023/021292, filed Dec. 21, 2023, which claims priority to and the benefit of Korean Patent Application No. 10-2023-0000639, filed Jan. 3, 2023, the disclosures of which are incorporated herein by reference in its entirety.

### FIELD

The present disclosure relates to a fixed contact part and a breaker including the same, and more particularly, to a fixed contact part having a structure capable of improving assembling convenience and maintaining a stable assembled state, and a breaker including the same.

### BACKGROUND

A breaker is electrically connected to an external power source and an external load and serves to prevent damage to the power source and the load. The breaker has a plurality of contacts configured to come into contact with each other or separate from each other.

In case that the plurality of contacts is in contact with each other, the external power source and the external load are electrically connected to each other, such that a current may flow. In case that an abnormal current is detected, the plurality of contacts is separated from one another. Therefore, the electrical conduction between the external power source and the external load is blocked, which may prevent damage to the power source and the load caused by the abnormal current.

Some of the plurality of contacts are fixedly installed at particular positions. The contact is referred to as a “fixed contact”. Some of the remaining contacts are configured to be movable in a direction opposite to a direction directed toward the fixed contact. The contact is referred to as a “movable contact”.

The fixed contact and the movable contact are coupled to other components exposed to the outside and conduct electricity. The external power source and the external load may be electrically connected to the fixed contact and the movable contact through the other components.

FIGS. 21 to 22 illustrate terminals 1100 and an arc runner 1200 provided in a breaker 1000 in the related art. The illustrated terminals 1100 include an inner terminal 1110 and an outer terminal 1120.

The inner terminal 1110 is accommodated in the breaker 10, coupled to the outer terminal 1120 with a housing interposed therebetween, and configured to conduct electricity. The outer terminal 1120 is exposed to the outside of the breaker 10 and conductively connected to the power source or the load.

That is, in the breaker 1000 in the related art, the inner terminal 1110 and the outer terminal 1120 collectively serve as the fixed contact conductively connected to the external power source or the external load. Therefore, a configuration is required to fixedly couple the inner terminal 1110 and the outer terminal 1120 to each other and to the housing.

In addition, the breaker 1000 has the arc runner 1200 configured to guide a generated arc to an arc extinguishing part (not illustrated). The arc runner 1200 is coupled to the inner terminal 1110 and configured to guide the arc generated on the fixed contact (not illustrated) provided on the inner terminal 1110.

Therefore, a configuration is also required to maintain a coupled state between the arc runner 1200 and the inner terminal 1110. In the illustrated embodiment, a terminal coupling end 1210 of the arc runner 1200 is inserted and coupled into a runner accommodation groove 1111 formed in the inner terminal 1110.

That is, an additional process of manufacturing the inner terminal 1110 and the outer terminal 1120 separately, further forming the runner accommodation groove 1111 and the terminal coupling end 1210, and coupling the terminal coupling end 1210 to the runner accommodation groove 1111 is required. Therefore, there is a concern that the process of manufacturing the breaker 1000 is complicated, and manufacturing costs and time are increased.

Korean Utility Model Application Laid-Open No. 20-2017-0003310 discloses a cradle of a draw-out air circuit breaker. Specifically, the preceding document discloses the cradle of the draw-out air circuit breaker for coupling a main circuit terminal to a base of the cradle even without a separate fixing member.

However, the cradle disclosed in the preceding document only provides a method of easily coupling the main circuit terminal. The preceding document discloses only a method of easily coupling the main circuit terminal to an outer box but does not provide a method of easily coupling other components, e.g., an arc runner and the like to the main circuit terminal.

Korean Patent No. 10-0914207 discloses an air circuit breaker. Specifically, the preceding document discloses the air circuit breaker capable of increasing the number of screw fastening points, a movement speed of an arc, and an extinguishing speed by using a fixing protrusion provided on an arc runner, and a protrusion fixing means configured to engage with the fixing protrusion and fix the fixing protrusion.

However, the fixed contactor and the arc runner disclosed in the preceding document require a process of inserting the fixing protrusion provided on the arc runner into an insertion portion recessed in a fixed contactor in order to assemble the fixed contactor and the arc runner. Therefore, the preceding document also fails to provide a method of coupling the fixed contactor and the arc runner by means of a simple structure.

Furthermore, the preceding documents fail to provide a method of coupling the fixed contactor and the arc runner, easily coupling the fixed contactor and the arc runner to the housing or the like, and maintaining a stable coupled state.
Korean Utility Model Application Laid-Open No. 20-2017-0003310 (Sep. 25, 2017)
Korean Patent No. 10-0914207 (Aug. 27, 2009)

### SUMMARY

The present disclosure has been made in an effort to solve the above-mentioned problem, and an object of the present disclosure is to provide a fixed contact part having a structure capable of improving assembling convenience, and a breaker including the same.

Another object of the present disclosure is to provide a fixed contact part having a structure capable of simplifying an assembling process, and a breaker including the same.

Still another object of the present disclosure is to provide a fixed contact part having a structure capable of maintaining a stable coupled state, and a breaker including the same.

Yet another object of the present disclosure is to provide a fixed contact part having a structure capable of coupling components while minimizing the number of additional coupling members, and a breaker including the same.

Still yet another object of the present disclosure is to provide a fixed contact part having a structure capable of reducing manufacturing costs, and a breaker including the same.

Technical problems to be solved by the present disclosure are not limited to the above-mentioned technical problems, and other technical problems, which are not mentioned above, may be clearly understood from the following descriptions by those skilled in the art to which the present disclosure pertains.

One aspect of the present disclosure provides a fixed contact part including: a fixed contact bar conductively connected to an external power source or an external load; a fixed contact coupled to the fixed contact bar and configured to come into contact with a movable contact; and an arc runner positioned at one side of the fixed contact bar based on a height direction and configured to guide a generated arc, in which the fixed contact bar includes: a first extension portion extending in one direction; and a second extension portion continuously connected to the first extension portion while having a predetermined angle with respect to the first extension portion, and in which the arc runner is seated and supported on the second extension portion.

In this case, the fixed contact part may be provided, in which the fixed contact bar includes an arc runner support portion protruding from one end directed toward the arc runner, among ends of the second extension portion, and configured to support the arc runner.

In addition, the fixed contact part may include a gas generation member configured to generate gas while chemically reacting with heat, in which the gas generation member is accommodated in the arc runner and supported by the arc runner.

In this case, the fixed contact part may be provided, in which the gas generation member includes: a gas generation body accommodated in the arc runner; and a gas generation arm extending from one end directed toward the fixed contact bar, among ends of the gas generation body, and configured to surround the second extension portion, and the fixed contact bar includes a gas generation member accommodation groove recessed at one end directed toward the gas generation member, among ends of the second extension portion, and configured to at least partially accommodate the gas generation arm.

In addition, the fixed contact part may be provided, in which the gas generation member accommodation groove is recessed at an edge of one end of the second extension portion.

In this case, the fixed contact part may include a gas generation member configured to generate gas while chemically reacting with heat, accommodated in the arc runner, and supported by the arc runner, in which the arc runner includes: an arc runner body disposed to overlap the gas generation member; and an arc runner arm extending from one end directed toward the fixed contact bar, among ends of the arc runner body, and configured to surround the second extension portion, and in which the fixed contact bar includes an arc runner accommodation groove recessed at one end directed toward the arc runner, among ends of the second extension portion, and configured to at least partially accommodate the arc runner arm.

In addition, the fixed contact part may be provided, in which the arc runner accommodation groove is recessed at an edge of one end of the second extension portion.

In this case, the fixed contact part may be provided, in which the gas generation member includes: a gas generation body accommodated in the arc runner; and a gas generation arm extending from one end directed toward the fixed contact bar, among ends of the gas generation body, and configured to surround the second extension portion, and in which the fixed contact bar includes a gas generation member accommodation groove recessed at one end of the second extension portion and configured to at least partially accommodate the gas generation arm and communicate with the arc runner accommodation groove.

In addition, the fixed contact part may be provided, in which the arc runner includes: a first arc runner body extending in a height direction of the fixed contact bar; a second arc runner body extending in one direction while having a predetermined angle with respect to the first arc runner body; a third arc runner body extending in the height direction of the fixed contact bar while having a predetermined angle with respect to the second arc runner body and configured to face the first arc runner body; and an accommodation space formed by being surrounded by the first arc runner body, the second arc runner body, and the third arc runner body.

In this case, the fixed contact part may be provided, in which the third arc runner body extends to be inclined in a direction toward the first arc runner body.

In addition, the fixed contact part may include: a gas generation member configured to generate gas while chemically reacting with heat, accommodated in the arc runner, and supported by the arc runner, in which the gas generation member includes: a gas generation body formed to have a width larger than a length of the second arc runner body and accommodated in the accommodation space; and a gas generation arm extending from one end directed toward the fixed contact bar, among ends of the gas generation body, and configured to surround the second arc runner body in a width direction.

In this case, the fixed contact part may be provided, in which the gas generation member includes an arc runner accommodation groove recessed in one surface directed toward the third arc runner body, among surfaces of the gas generation body, and configured to accommodate the third arc runner body.

In addition, another aspect of the present disclosure may provide a breaker including: a frame in which a space is formed; a housing coupled to the frame while covering the space; and a fixed contact part accommodated in the space, coupled to the housing, partially exposed to the outside, and conductively connected to an external power source or an external load, in which the fixed contact part includes: a fixed contact bar configured to penetrate the housing and partially exposed to the outside; and an arc runner positioned above the fixed contact bar and configured to guide a generated arc to the outside, and in which the housing includes: a contact bar accommodation space recessed in one surface directed toward the frame and configured to accommodate a partial portion of the fixed contact bar and the arc runner; and a contact bar through-hole formed through the inside of the contact bar accommodation space and coupled to the fixed contact bar.

In this case, the breaker may be provided, in which the fixed contact bar includes: a first extension portion extending in one direction, configured to penetrate the contact bar through-hole, and partially exposed to the outside; and a second extension portion positioned in the contact bar accommodation space and extending in a direction opposite to the arc runner while having a predetermined angle with respect to the first extension portion, and the arc runner partially surrounds the second extension portion.

In addition, the breaker may be provided, in which the arc runner includes: a first arc runner body provided to be in contact with one surface of the housing and extending in the other direction; a second arc runner body extending in a direction toward the frame while having a predetermined angle with respect to the first arc runner body; a third arc runner body extending in the other direction while having a predetermined angle with respect to the second arc runner body and configured such that an end of the third arc runner body based on the extension direction is coupled to one surface of the housing; and an accommodation space formed by being surrounded by the first arc runner body, the second arc runner body, and the third arc runner body.

In this case, the breaker may include: a gas generation member positioned above the fixed contact bar, coupled to the housing, and configured to generate gas while chemically reacting with heat generated together with the arc, in which the gas generation member includes: a gas generation body accommodated in the accommodation space; and a pair of gas generation arms extending from a lower end of the gas generation body and configured to surround the second extension portion and the second arc runner body in a width direction.

In addition, the breaker may be provided, in which the fixed contact bar includes an arc runner support portion protruding from an upper end of the second extension portion, the arc runner support portion is in contact with a partial portion of the housing that surrounds the contact bar through-hole from above, and the second extension portion is in contact with another portion of the housing that surrounds the contact bar through-hole from below.

In this case, the breaker may be provided, in which the fixed contact bar includes housing accommodation grooves recessed inward at a pair of edges positioned above the first extension portion, the housing accommodation grooves being configured to accommodate a partial portion of the housing, and the partial portion of the housing accommodated in the housing accommodation grooves is configured to support the first extension portion.

In addition, the breaker may include: a gas generation member positioned above the fixed contact bar, coupled to the housing, and configured to generate gas while chemically reacting with heat generated together with the arc, in which the arc runner includes arc runner arms extending downward, spaced apart from each other in a width direction, and configured to surround the second extension portion in the width direction, and in which the gas generation member includes gas generation arms extending downward, spaced apart from each other in a width direction, configured to surround the second extension portion in the width direction, and disposed to overlap the arc runner arms so as to face the housing with the arc runner arms interposed therebetween.

In this case, the breaker may be provided, in which the fixed contact bar includes: an arc runner accommodation groove recessed at an upper edge of the second extension portion and configured to accommodate the arc runner arm; and a gas generation member accommodation groove positioned to be closer to the space of the frame than the arc runner accommodation groove, recessed at the upper edge of the second extension portion, and configured to accommodate the gas generation arm and communicate with the arc runner accommodation groove.

With the above-mentioned configuration, the fixed contact part and the breaker including the same according to the embodiment of the present disclosure may improve the assembling convenience.

The fixed contact part includes the fixed contact bar partially exposed to the outside of the breaker and conductively connected to the external power source or the external load. The fixed contact may be coupled to the fixed contact bar and configured to come into contact with or separate from the movable contact accommodated in the internal space of the frame.

In this case, the fixed contact bar may be integrally formed. Some components of the fixed contact bar, i.e., the first extension portion, penetrate the housing and are partially exposed to the outside. Other components of the fixed contact bar, i.e., the second extension portion, are accommodated in the contact bar accommodation portion formed in the housing.

That is, the fixed contact part may be conductively connected to the external power source or the external load and the movable contact accommodated in the frame only by the process of coupling the integrated fixed contact bar penetratively to the housing.

Therefore, it is possible to improve the assembling convenience in comparison with a case in which a plurality of components positioned inside and outside a housing constitute a fixed contact bar.

In addition, with the above-mentioned configuration, the fixed contact part and the breaker including the same according to the embodiment of the present disclosure may simplify the assembling process.

As described above, the coupling between the fixed contact bar and the housing may be achieved by allowing the first extension portion to penetrate the contact bar through-hole formed through the housing. After the fixed contact bar is coupled, the arc runner and the gas generation member provided in the fixed contact part are fastened to the housing in the state in which the arc runner and the gas generation member are coupled to each other.

Therefore, the process of assembling the fixed contact part and the housing may be simplified.

In addition, with the above-mentioned configuration, the fixed contact part and the breaker including the same according to the embodiment of the present disclosure may stably maintain the coupled state.

The first extension portion exposed to the outside of the housing extends in the forward/rearward direction. The second extension portion accommodated in the contact bar accommodation portion extends in the upward/downward direction while having a predetermined angle with respect to the first extension portion. When the first extension portion penetrates the contact bar through-hole, the second extension portion comes into contact with the inner surface of the housing and supports the first extension portion from below.

In the embodiment, the arc runner support portion may protrude from the upper end of the second extension portion. When the first extension portion penetrates the contact bar through-hole, the arc runner support portion comes into contact with the inner surface of the housing and supports the first extension portion from above.

Meanwhile, the housing accommodation groove is recessed at the edge of the first extension portion. A partial portion of the housing is accommodated in the housing accommodation groove and supports the first extension portion at one side based on the height direction.

In addition, the gas generation member accommodation groove and the arc runner accommodation groove are formed at the edge of the second extension portion. The gas generation arm is accommodated in the gas generation member accommodation groove, and the arc runner groove is accommodated in the arc runner accommodation groove. In the embodiment, the gas generation arm and the arc runner groove may support the second extension portion.

Furthermore, the gas generation member is partially accommodated in the accommodation space formed in the arc runner. The gas generation member is supported by the arc runner. In this case, the gas generation arm is positioned inward from the arc runner arm, i.e., positioned in the direction toward the frame. That is, the gas generation member and the arc runner are coupled to support each other at different positions.

Therefore, the components of the fixed contact part are supported by one another, such that the coupled state therebetween may be stably maintained.

In addition, with the above-mentioned configuration, in the fixed contact part and the breaker including the same according to the embodiment of the present disclosure, the components may be coupled to one another, and the number of additional coupling members may be minimized.

As described above, the components of the fixed contact part may be coupled while being supported by one another. Therefore, the coupled state between the components of the fixed contact part may be stably maintained.

In addition, the fixed contact bar may be penetratively coupled to the contact bar through-hole formed in the housing. One side of the fixed contact bar based on the height direction is supported by the gas generation member and the arc runner. Therefore, the fixed contact bar may be supported at the plurality of points by the shape thereof, the housing, the gas generation member, and the arc runner.

In addition, the gas generation member and the arc runner include the gas fastening hole and the arc fastening hole disposed to overlap each other and thus penetrated by the fastening member. The fastening member, which penetrates the gas fastening hole and the arc fastening hole, is coupled to the housing fastening hole formed in the housing. That is, the gas generation member and the arc runner may be coupled to the housing only by the fastening member.

Therefore, the fixed contact part and the housing may be coupled while the number of coupling members is minimized.

In addition, with the above-mentioned configuration, the fixed contact part and the breaker including the same according to the embodiment of the present disclosure may reduce manufacturing costs.

As described above, the fixed contact bar penetrates the housing, such that the fixed contact bar is partially exposed to the inside of the frame, and the fixed contact bar is partially exposed to the outside of the frame. In addition, the gas generation member and the arc runner are coupled to the housing together by the fastening member and configured to support the fixed contact bar.

Therefore, the coupling process may be simplified, and the number of members required for the fastening process or the like may be reduced. Therefore, the manufacturing costs and time may be reduced.

The effects of the present disclosure are not limited to the above-mentioned effects, and it should be understood that the effects of the present disclosure include all effects that may be derived from the detailed description of the present disclosure or the appended claims.

### BRIEF DESCRIPTION OF THE DRAWINGS

FIGS. 1 and 2 are perspective views illustrating a breaker according to an embodiment of the present disclosure.

FIG. 3 is a cross-sectional view taken along line A-A and illustrating the breaker in FIGS. 1 and 2.

FIGS. 4 and 5 are exploded perspective views illustrating a configuration of the breaker in FIGS. 1 and 2.

FIG. 6 is a perspective view illustrating a fixed contact part and a housing provided in the breaker in FIGS. 1 and 2.

FIG. 7 is a perspective view illustrating the fixed contact part in FIG. 6.

FIG. 8 is a side view illustrating the fixed contact part in FIG. 6.

FIG. 9 is a top plan view illustrating the fixed contact part in FIG. 6.

FIGS. 10 and 11 are perspective views illustrating a gas generation member provided in the fixed contact part in FIG. 6.

FIGS. 12 and 13 are perspective views illustrating an arc runner provided in the fixed contact part in FIG. 6.

FIGS. 14 and 15 are perspective views illustrating a housing in FIG. 6.

FIG. 16 is a front view illustrating the housing in FIGS. 14 and 15.

FIG. 17 is a rear view illustrating the housing in FIGS. 14 and 15.

FIG. 18 is a cross-sectional perspective view illustrating a coupling relationship between the fixed contact part and the housing in FIG. 6.

FIG. 19 is a cross-sectional side view illustrating a coupling relationship between the fixed contact part and the housing in FIG. 6.

FIG. 20 is a cross-sectional perspective view illustrating a coupling relationship between the fixed contact part and the housing in FIG. 6.

FIG. 21 is an exploded perspective view illustrating a coupling relationship between a terminal and an arc runner provided in a breaker in the related art.

FIG. 22 is a cross-sectional side view illustrating a coupling relationship between the terminal and the arc runner of the breaker in FIG. 21.

### DETAILED DESCRIPTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways and is not limited to the embodiments described herein. In the drawings, a part irrelevant to the description will be omitted to clearly describe the present disclosure, and the same or similar constituent elements will be designated by the same reference numerals throughout the specification.

Terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own invention by the best method.

Therefore, the embodiments disclosed in the present specification and the configurations illustrated in the drawings are the exemplary embodiments of the present disclosure and do not represent all the technical spirit of the present disclosure. Accordingly, it should be appreciated that various equivalents and modified examples capable of substituting the embodiments may be made at the time of filing the present application.

In the following description, the description of some constituent elements may be omitted in order to clarify the features of the present disclosure.

### 1. Definition of Terms

The term “communication” used in the following description means that one or more members are connected to one another while implementing fluid communication. In the embodiment, the communication may be implemented by members such as conduits, pipes, tubes, and the like. The term “communication” in the following description may be used to mean that one or more members are “fluidly connected” to one another.

The terms “electric conduction” used in the following description means that one or more members are connected to one another so that the members may transmit electric current or electrical signal to one another. In the embodiment, the electric conduction may be implemented in a wired manner by a conductive wire member or the like or implemented in a wireless manner by Bluetooth, Wi-Fi, RFID, or the like. In the embodiment, the electric conduction may include a meaning of “communication”.

The term “fluid” used in the following description refers to any form of material that may flow by an external force and change in shape, volume, or the like. In the embodiment, the fluid may be a liquid such as water or a gas such as air.

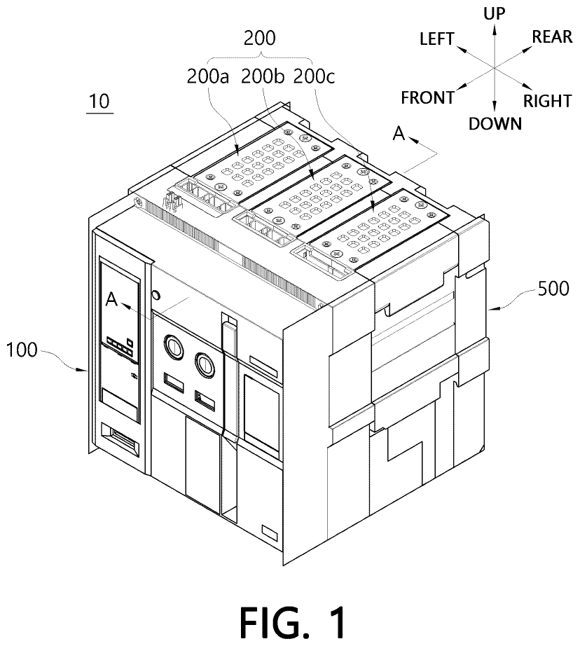

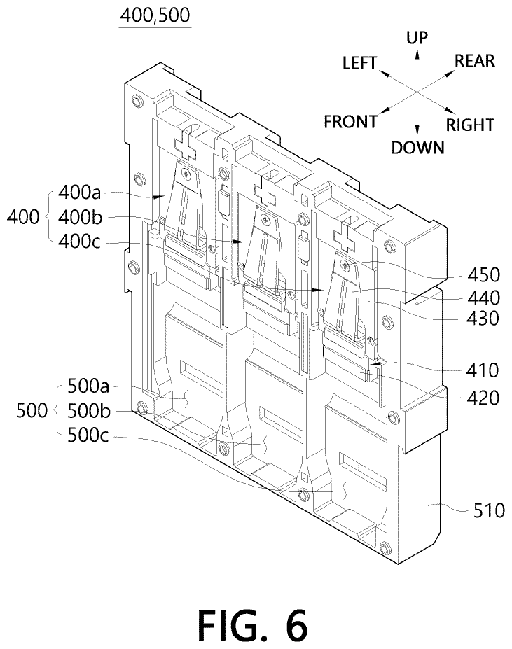

In the following description, the terms “upper side,” “lower side,” “left side,” “right side,” “front side,” and “rear side” may be understood with reference to a coordinate system illustrated in FIGS. 1 and 6.

### 2. Description of Configuration of Breaker 10 According to Embodiment of Present Disclosure

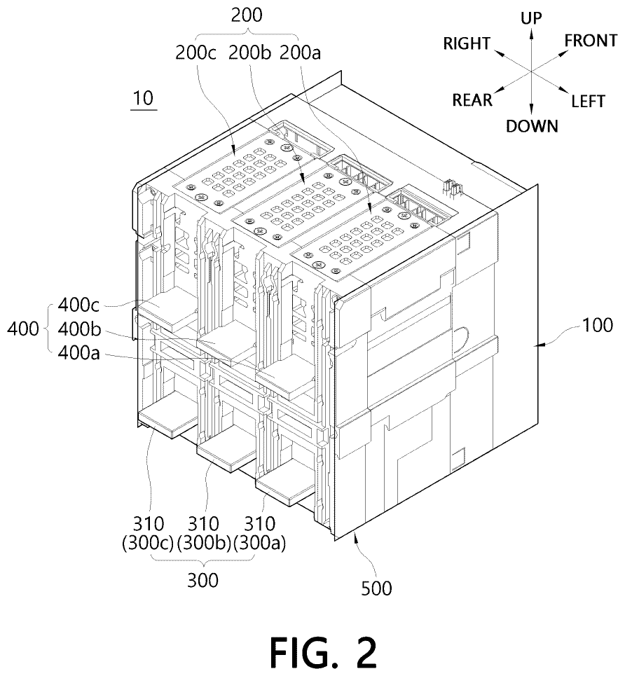

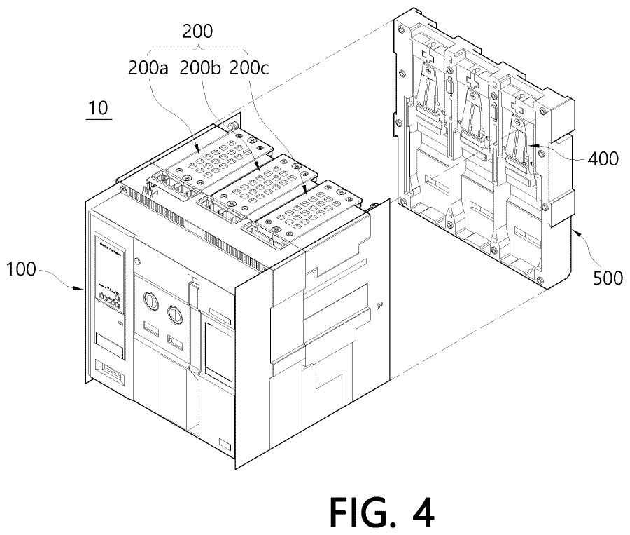

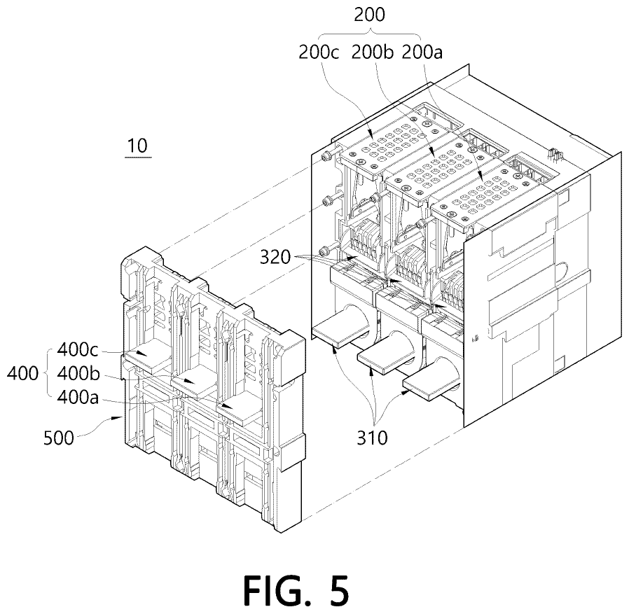

FIGS. 1 to 5 illustrate the breaker 10 according to the embodiment of the present disclosure. The breaker 10 performs electrical conduction with an external power source and an external load. In the embodiment, the breaker 10 may be conductively connected to the external power source and the external load through a conductive wire member (not illustrated) or the like.

In the embodiment, the breaker 10 according to the embodiment of the present disclosure may be provided as an air circuit breaker (ACB). However, the features of the breaker 10 according to the embodiment of the present disclosure to be described below and the features of a fixed contact part 400 and a housing 500 included in the breaker 10 may be applied to various types of breakers such as a vacuum circuit breaker (VCB) or a molded case circuit breaker (MCCB).

Because a process in which the breaker 10 is electrically connected to the external power source and the external load and allows or blocks electrical conduction between the external power source and the external load is a well-known technology, a detailed description thereof will be omitted.

In the illustrated embodiment, the breaker 10 includes a frame 100, an arc extinguishing member 200, a conduction part 300, the fixed contact part 400, and the housing 500. Among the components, the fixed contact part 400 and the housing 500 will be described separately.

The frame 100 defines an external shape of the breaker 10. A space may be formed in the frame 100 and accommodate other components of the breaker 10. In the illustrated embodiment, the arc extinguishing member 200, the conduction part 300, the fixed contact part 400, and the housing 500 are accommodated in the frame 100.

In this case, the arc extinguishing member 200 may be disposed to be exposed to the outside of the frame 100. In the illustrated embodiment, the arc extinguishing member 200 is disposed to be exposed upward from the frame 100.

In addition, the conduction part 300 and the fixed contact part 400 may also be disposed to be exposed to the outside of the frame 100. In the illustrated embodiment, some components of the conduction part 300 and the fixed contact part 400 are disposed to be partially exposed rearward from the frame 100. The external power source and the external load may be conductively connected to the conduction part 300 and the fixed contact part 400.

Furthermore, the housing 500 may be coupled to the frame 100 and disposed to be exposed to the outside. In the illustrated embodiment, the housing 500 may be coupled to a rear side of the frame 100. The conduction part 300 and the fixed contact part 400 may partially penetrate the housing 500 and be exposed to the outside.

The frame 100 may have any shape capable of accommodating the other components of the breaker 10 and conductively connecting the other components to the outside. In the illustrated embodiment, the frame 100 has a quadrangular column shape having a length in a forward/rearward direction, a height in an upward/downward direction, and a width in a leftward/rightward direction.

The shape of the frame 100 may vary depending on the shape of the housing 500.

The arc extinguishing member 200 is provided at one side of the frame 100 based on a height direction, i.e., an upper side in the illustrated embodiment.

The arc extinguishing member 200 is spaced apart from a movable contact 322 and a fixed contact 420 and defines a passageway in which the generated arc is discharged to the outside of the breaker 10 while being extinguished. The arc extinguishing member 200 is positioned adjacent to the fixed contact 420. The generated arc may extend along an arc runner 440 and be discharged to the outside while being extinguished by the arc extinguishing member 200.

The arc extinguishing member 200 is accommodated in a space formed in the frame 100. In this case, one side of the arc extinguishing member 200 is positioned adjacent to the fixed contact 420 accommodated in the space of the frame 100, and the other side of the arc extinguishing member 200 is exposed to the outside of the frame 100. In the illustrated embodiment, a lower side of the arc extinguishing member 200 is positioned adjacent to the fixed contact 420, and an upper side of the arc extinguishing member 200 is exposed to the outside of the frame 100.

To this end, the arc extinguishing member 200 may be positioned to be biased toward one side of the frame 100 based on a longitudinal direction, i.e., a rear side in the illustrated embodiment.

The arc extinguishing member 200 may be provided as a plurality of arc extinguishing members 200. The plurality of arc extinguishing members 200 may be disposed to be spaced apart from one another and configured to extinguish the arcs generated between the plurality of fixed contacts 420 and the movable contact 322.

In the illustrated embodiment, three arc extinguishing members 200 are provided and include a first arc extinguishing member 200a, a second arc extinguishing member 200b, and a third arc extinguishing member 200c. The first to third arc extinguishing members 200a, 200b, and 200c are disposed to be spaced apart from one another in a width direction of the frame 100, i.e., the leftward/rightward direction. The first to third arc extinguishing members 200a, 200b, and 200c are configured to discharge the arcs generated on the three pairs of movable contacts 322 and fixed contacts 420 while extinguishing the arcs.

The arc extinguishing member 200 may have any shape that may extinguish and discharge the arc occurring when the movable contact 322 and the fixed contact 420 are separated. In the illustrated embodiment, the arc extinguishing member 200 has a polygonal column shape having a quadrangular cross-section and having a height in the upward/downward direction.

Although no reference numeral is assigned, the arc extinguishing member 200 may include any configuration capable of applying a suction force to the generated arc. For example, the arc extinguishing member 200 may include a plurality of grids disposed to be spaced apart from one another, a frame configured to support the plurality of grids, and a mesh net configured to filter out the arc having passed through the plurality of grids.

Because the configuration and operating process of the arc extinguishing member 200 are well-known technologies, a detailed description thereof will be omitted.

The conduction part 300 defines one configuration in which the breaker 10 is connected to the external power source and the external load. The conduction part 300 may be conductively connected to any one of the external power source and the external load. Therefore, it is understood that the other of the external power source and the external load is conductively connected to the fixed contact part 400.

The conduction part 300 is coupled to the frame 100. Some components of the conduction part 300 are fixedly coupled to the frame 100, and other components of the conduction part 300 are rotatably coupled to the frame 100.

The conduction part 300 is partially accommodated in an internal space of the frame 100. Some components of the conduction part 300 are accommodated in the internal space of the frame 100 without being exposed to the outside. The other components of the conduction part 300 are electrically connected to some components of the conduction part 300 and exposed to the outside of the frame 100.

The conduction part 300 is positioned adjacent to the arc extinguishing member 200. The arc, which is extended by the movement of the conduction part 300, may be guided to the arc extinguishing member 200. In the illustrated embodiment, the conduction part 300 is positioned below the arc extinguishing member 200.

The conduction part 300 is positioned adjacent to the fixed contact part 400. Some components (i.e., a movable contact part 320 to be described below) of the conduction part 300 may move in a direction toward the fixed contact part 400 or a direction opposite to the direction toward the fixed contact part 400. The movable contact 322 and the fixed contact 420 may be brought into contact with each other or separated from each other by the movement.

The conduction part 300 is coupled to the housing 500. Specifically, the other components of the conduction part 300 may be penetratively coupled to the housing 500 and exposed to the outside.

The conduction part 300 may be made of an electrically conductive material. In the embodiment, the conduction part 300 may be made of copper (Cu), aluminum (Al), or an alloy material containing copper (Cu) and aluminum (Al).

The conduction part 300 may be provided as a plurality of conduction parts 300. The plurality of conduction parts 300 may be disposed to be spaced apart from one another and conductively connected to the external power source and the external load. In the illustrated embodiment, three conduction parts 300 are provided and include a first conduction part 300a, a second conduction part 300b, and a third conduction part 300c. The first to third conduction parts 300a, 300b, and 300c are disposed to be spaced apart from one another in the width direction of the frame 100, i.e., the leftward/rightward direction in the illustrated embodiment.

The first to third conduction parts 300a, 300b, and 300c are positioned adjacent to the first to third arc extinguishing members 200a, 200b, and 200c. In addition, the first to third conduction parts 300a, 300b, and 300c are positioned adjacent to first to third fixed contact parts 400a, 400b, and 400c.

The number of conduction parts 300 and the method of disposing the conduction parts 300 may vary depending on the number of arc extinguishing members 200, the number of fixed contact parts 400, the method of disposing the arc extinguishing members 200, and the method of disposing fixed contact parts 400.

In the illustrated embodiment, the conduction part 300 includes a terminal 310 and the movable contact part 320.

The terminal 310 is a portion through which the conduction part 300 is exposed to the outside and conductively connected to the external power source or the external load. The terminal 310 is positioned at one side of the frame 100 based on the longitudinal direction, i.e., the rear side in the illustrated embodiment. The terminal 310 extends toward one side, i.e., the rear side, and one end based on the extension direction is exposed to the outside of the frame 100.

The terminal 310 is coupled to the housing 500. The terminal 310 is accommodated in a terminal coupling portion 520 formed in the housing 500. A rear portion of the terminal 310 penetrates a terminal through-hole 522 and is exposed to the outside of the housing 500.

Therefore, the terminal 310 may be kept coupled to the frame 100 and the housing 500 without moving. In other words, the terminal 310 is fixedly coupled to the frame 100 and the housing 500.

The terminal 310 may have any shape that may be exposed to the outside of the frame 100 and the housing 500 so as to be conductively connected to the external power source or the external load. In the illustrated embodiment, the terminal 310 has a quadrangular plate shape having a quadrangular cross-section and extending in the forward/rearward direction.

The other side of the terminal 310 based on the extension direction, i.e., the front side in the illustrated embodiment is positioned in the internal space of the frame 100. The other side of the terminal 310 is conductively connected to the movable contact part 320.

The movable contact part 320 is configured to come into contact with or separate from the fixed contact 420 to constitute or release an electrically connected state between the breaker 10 and the external power source and the external load.

The movable contact part 320 is movably accommodated in the internal space of the frame 100. In the embodiment, the movable contact part 320 may be provided to be rotatable about any point in the internal space of the frame 100 as an axis. In the illustrated embodiment, the movable contact part 320 may rotate clockwise and come into contact with the fixed contact 420. In addition, the movable contact part 320 may rotate counterclockwise and separate from the fixed contact 420.

The movable contact part 320 is coupled to the terminal 310. The movable contact part 320 is conductively coupled to the terminal 310. As described above, the terminal 310 is fixedly coupled to the frame 100 and the housing 500, and the movable contact part 320 is movably accommodated in the internal space of the frame 100.

Therefore, a partial portion of the movable contact part 32, which is coupled and electrically connected to the terminal 310, has a braided shape, such that the coupled and electrically connected state between the movable contact part 320 and the terminal 310 regardless of the movement of the movable contact part 320.

In the illustrated embodiment, the movable contact part 320 includes a movable contact bar 321 and the movable contact 322.

The movable contact bar 321 defines one configuration of the movable contact part 320. The movable contact bar 321 is coupled to and electrically connected to the partial portion (i.e., the portion where the movable contact part 320 is coupled to the terminal 310) and the movable contact 322. Therefore, the terminal 310 may be conductively connected to the movable contact 322.

The movable contact bar 321 extends between the terminal 310 and the fixed contact part 400 in the upward/downward direction in the illustrated embodiment. One side of the movable contact bar 321 based on the extension direction, i.e., the lower side in the illustrated embodiment is coupled and electrically connected to the partial portion. The other side of the movable contact bar 321 based on the extension direction, i.e., the upper side in the illustrated embodiment is positioned adjacent to the fixed contact part 400. The movable contact 322 is positioned adjacent to the other end of the movable contact bar 321.

The movable contact bar 321 may be provided to be rotatable about one position based on the extension direction as an axis. In the illustrated embodiment, the movable contact bar 321 may rotate about one position biased toward the lower side of the center based on the extension direction.

The movable contact 322 comes into contact with or separate from the fixed contact 420 to allow or block the electrical conduction between the breaker 10 and the external power source and the external load. In addition, in case that an abnormal current, i.e., an overcurrent or the like occurs in the state in which the breaker 10 is electrically connected to the external power source and the external load, the movable contact 322 may be separated from the fixed contact 420 by an electrical repulsive force. Therefore, the generated arc may be guided to the arc extinguishing member 200 and discharged to the outside while being extinguished.

The movable contact 322 is coupled and electrically connected to the movable contact bar 321. In the illustrated embodiment, the movable contact 322 is positioned adjacent to the other end, i.e., an upper end of the movable contact bar 321 based on the extension direction. The movable contact 322 is positioned at one side, i.e., the rear side in the illustrated embodiment that faces the fixed contact 420 among the sides of the movable contact bar 321.

Because the process in which the movable contact 322 and the fixed contact 420 come into contact with each other or separate from each other so that the breaker 10 allows or blocks the electrical conduction between the external power source and the external load is a well-known technology, a detailed description thereof will be omitted.

### 3. Description of Fixed Contact Part 400 and Housing 500 According to Embodiment of Present Disclosure

With reference back to FIGS. 1 to 5, the breaker 10 according to the embodiment of the present disclosure includes the fixed contact part 400 and the housing 500.

The fixed contact part 400 conductively comes into contact with or separates from the conduction part 300. As described above, the breaker 10 may allow or block the electrically connected state between the external power source and the external load by means of the contact or separation. In addition, the fixed contact part 400 may be configured to guide the arc, which occurs when the conduction part 300 is separated, toward the arc extinguishing member 200.

The fixed contact part 400 is coupled to the frame 100 and the housing 500. Some components of the fixed contact part 400 may be positioned in the internal space of the frame 100 and come into contact with or separate from the movable contact part 320. Other components of the fixed contact part 400 may be exposed to the outside of the frame 100 and the housing 500 and conductively connected to the external power source or the external load.

In particular, the fixed contact part 400 according to the embodiment of the present disclosure may be configured to perform the function by means of the minimum number of components. Therefore, the process of manufacturing the fixed contact part 400 and coupling the fixed contact part 400 to other components may be easily performed.

In addition, the coupled state between the components, which constitute the fixed contact part 400 according to the embodiment of the present disclosure, and other components of the breaker 10 may be stably maintained. Therefore, the coupled state may be stably maintained even though pressure or the like occurs together with the arc as the movable contact 322 and the fixed contact 420 are separated.

The fixed contact part 400 is coupled to the frame 100. In the illustrated embodiment, the fixed contact part 400 is positioned at the rear side of the frame 100. Some components of the fixed contact part 400 are accommodated in the internal space of the frame 100. Other components of the fixed contact part 400 are exposed to the outside of the frame 100.

The fixed contact part 400 is positioned adjacent to the arc extinguishing member 200. Based on the fixed contact 420 as a starting position, the arc extending along the movable contact 322 moving away from the fixed contact 420 may be guided to the arc extinguishing member 200. In the illustrated embodiment, the fixed contact part 400 is positioned below the arc extinguishing member 200.

The fixed contact part 400 is positioned adjacent to some components of the conduction part 300. In the illustrated embodiment, the fixed contact part 400 is positioned above the terminal 310 and positioned rearward of the movable contact part 320. When the movable contact part 320 rotates clockwise or counterclockwise, the movable contact 322 and the fixed contact 420 may come into contact with each other or separate from each other.

The fixed contact part 400 is coupled to the housing 500. Among the components of the fixed contact part 400, some components of the fixed contact part 400 exposed to the outside of the frame 100 may be coupled to and supported by the housing 500. In this case, some components may penetrate the housing 500 and be exposed to the outside of the housing 500.

The fixed contact part 400 may be provided as a plurality of fixed contact parts 400. The plurality of fixed contacts parts 400 may be coupled to the frame 100 and the housing 500 at different positions. In the illustrated embodiment, three fixed contact parts 400 are provided and include a first fixed contact part 400a, a second fixed contact part 400b, and a third fixed contact part 400c. The first to third fixed contact parts 400a, 400b, and 400c are disposed to be spaced apart from one another in the width direction of the frame 100, i.e., the leftward/rightward direction in the illustrated embodiment.

The first to third fixed contact parts 400a, 400b, and 400c are positioned adjacent to the first to third arc extinguishing members 200a, 200b, and 200c and the first to third conduction parts 300a, 300b, and 300c.

The number of fixed contact parts 400 and the method of disposing the fixed contact parts 400 may vary depending on the number of arc extinguishing members 200, the number of conduction parts 300, the method of disposing the arc extinguishing members 200, and the method of disposing the conduction parts 300.

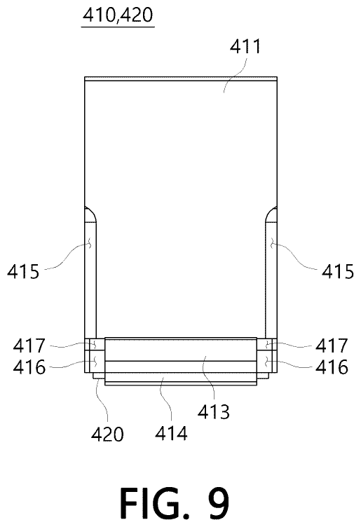

In the embodiment illustrated in FIGS. 6 to 13, the fixed contact part 400 includes a fixed contact bar 410, the fixed contact 420, a gas generation member 430, the arc runner 440, and a fastening member 450.

The fixed contact bar 410 defines one configuration of the fixed contact part 400. The fixed contact bar 410 is exposed to the outside of the frame 100 or the housing 500 and conductively connected to the external power source or the external load.

The fixed contact bar 410 is coupled and electrically connected to the fixed contact 420. When the fixed contact 420 comes into contact with the movable contact 322, the fixed contact bar 410 is conductively connected to the movable contact bar 321 and the terminal 310. Therefore, the breaker 10 may allow the electrical conduction between the external power source and the external load.

The fixed contact bar 410 may be made of an electrically conductive material. In the embodiment, the fixed contact bar 410 may be made of copper, aluminum, or an alloy material containing copper and aluminum.

The fixed contact bar 410 is partially accommodated in the space formed in the frame 100. In the illustrated embodiment, a part of a front side of the fixed contact bar 410 is accommodated in the space formed in the frame 100.

The fixed contact bar 410 is partially exposed to the outside of the frame 100 and coupled to the housing 500. A portion of the fixed contact bar 410, which is exposed to the outside, penetrates the housing 500 is exposed to the outside of the housing 500. In the illustrated embodiment, a part of a rear side of the fixed contact bar 410 is exposed to the outside of the housing 500.

In the embodiment, the fixed contact bar 410 may be formed as a single member. That is, a first extension portion 411 and a second extension portion 412, which define an external shape of the fixed contact bar 410, may be integrated. Therefore, a part of the single fixed contact bar 410 may be accommodated in the internal space of the frame 100, and another part of the single fixed contact bar 410 may be exposed to the outside of the frame 100.

Therefore, the number of components required to electrically connect the fixed contact part 400 to the outside may be reduced, and the fixed contact part 400 and the housing 500 may be easily performed.

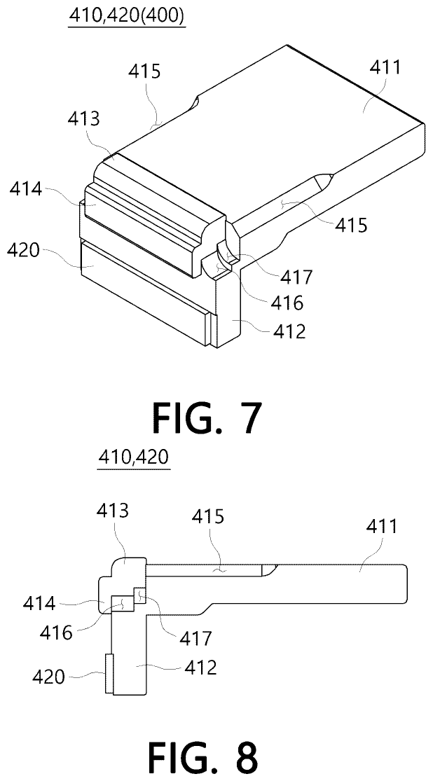

In the embodiment illustrated in FIGS. 7 to 9, the fixed contact bar 410 includes the first extension portion 411, the second extension portion 412, an arc runner support portion 413, a restriction protrusion 414, housing accommodation grooves 415, gas generation member accommodation grooves 416, and arc runner accommodation grooves 417.

The first extension portion 411 constitutes a part of a body of the fixed contact bar 410. The first extension portion 411 is a portion where the fixed contact bar 410 is coupled to the housing 500. Simultaneously, the first extension portion 411 is a portion where the fixed contact bar 410 is exposed to the outside of the housing 500 and conductively connected to the external power source or the external load.

The first extension portion 411 extends in the longitudinal direction of the frame 100, i.e., the forward/rearward direction in the illustrated embodiment. The extension direction of the first extension portion 411 is understood as a direction in which the frame 100 and the housing 500 are coupled to each other or separated from each other.

The first extension portion 411 may have any shape that may penetrate the housing 500 and be exposed to the outside of the housing 500. In the illustrated embodiment, the first extension portion 411 has a polygonal column shape having a length in the forward/rearward direction and having a height in the upward/downward direction that is smaller than a width in the leftward/rightward direction.

The shape of the first extension portion 411 may vary depending on a shape of a contact bar coupling portion 530 formed on the housing 500.

Among the surfaces of the first extension portion 411 extending in the longitudinal direction, the housing accommodation grooves 415 are recessed in the pair of surfaces disposed in the width direction, i.e., the left surface and the right surface in the illustrated embodiment.

The first extension portion 411 is continuously coupled to the second extension portion 412 while having a predetermined angle with respect to the second extension portion 412. In the embodiment, the predetermined angle may be a right angle.

The second extension portion 412 defines another part of the body of the fixed contact bar 410. The second extension portion 412 is coupled and electrically connected to the fixed contact 420. That is, the second extension portion 412 may be defined as a portion where the fixed contact bar 410 conductively comes into contact with or separates from the movable contact part 320.

The second extension portion 412 supports the fixed contact bar 410 coupled to the housing 500. That is, the second extension portion 412 may extend in a direction different from a direction in which a contact bar through-hole 532 is penetratively formed, and the second extension portion 412 may prevent the first extension portion 411, which penetrates the contact bar through-hole 532, from being arbitrarily separated.

The second extension portion 412 extends in the height direction of the first extension portion 411, i.e., the upward/downward direction in the illustrated embodiment while having a predetermined angle with respect to the first extension portion 411. In this case, the second extension portion 412 may extend in a direction toward the terminal 310, i.e., extend downward.

The second extension portion 412 may have any shape continuously connected to the first extension portion 411 and configured to maintain a stable coupled state between the fixed contact bar 410 and the housing 500. In the illustrated embodiment, the second extension portion 412 has a polygonal column shape having a height in the upward/downward direction and having a length in the forward/rearward direction that is smaller than a width in the leftward/rightward direction.

The second extension portion 412 is coupled and electrically connected to the fixed contact 420. The fixed contact 420 is coupled to one surface directed toward the internal space of the frame 100, i.e., the front surface in the illustrated embodiment among the surfaces of the second extension portion 412.

The gas generation member accommodation grooves 416 and the arc runner accommodation grooves 417 are formed in edges based on the width direction of one end directed toward the arc extinguishing member 200, among the ends of the second extension portion 412 on the basis of the extension direction, i.e., a left upper edge and a right upper edge of the upper end in the illustrated embodiment.

The arc runner support portion 413 protrudes in the height direction from a surface of one end of the second extension portion 412, i.e., the upper surface in the illustrated embodiment.

In addition, the restriction protrusion 414 protrudes from one surface of the second extension portion 412, i.e., the front surface in the illustrated embodiment in a direction toward the internal space of the frame 100, i.e., protrudes forward so that the restriction protrusion 414 is spaced apart from the fixed contact 420.

The arc runner support portion 413 supports the arc runner 440 coupled to the housing 500. The arc runner support portion 413 may be positioned below the arc runner 440 and configured to support a lower end of the arc runner 440.

The arc runner support portion 413 is continuously connected to the second extension portion 412. The arc runner support portion 413 protrudes upward from the surface of one end directed toward the arc runner 440, i.e., the surface of the upper end in the illustrated embodiment among the surfaces of the second extension portion 412.

A protruding length of the arc runner support portion 413 may be determined depending on a relative position between the arc runner 440 and the fixed contact bar 410. Specifically, the arc runner support portion 413 may protrude by a length between the lower end of the arc runner 440 coupled to the housing 500 and the surface of the upper end of the second extension portion 412.

Therefore, a lower side of the arc runner 440 coupled to the housing 500 is supported by the second extension portion 412, such that the coupled state of the arc runner 440 may be stably maintained. Simultaneously, the arc runner support portion 413 is also pressed downward by the arc runner 440, such that the predetermined angle with respect to the contact bar through-hole 532 may be maintained.

Therefore, the arc runner support portion 413 may support the arc runner 440 and maintain the coupled state of the fixed contact bar 410.

In addition, the arc runner support portion 413 may restrict a length by which the first extension portion 411 penetrates the contact bar through-hole 532.

That is, as described above, the second extension portion 412 extends downward and supports the fixed contact bar 410 from below. In this case, the arc runner support portion 413 protrudes upward and supports the fixed contact bar 410 from above. That is, the second extension portion 412 comes into contact with a contact housing body 510 from below, and the arc runner support portion 413 comes into contact with the contact housing body 510 from above.

Therefore, it is possible to restrict a length by which the first extension portion 411 penetrates the contact bar through-hole 532. In addition, the fixed contact bar 410 coupled to the contact bar through-hole 532 may be supported by the contact housing body in the upward/downward direction.

The restriction protrusion 414 is positioned adjacent to the arc runner support portion 413.

The restriction protrusion 414 is configured to restrict a movement distance of the movable contact bar 321. The movable contact bar 321 may move toward the fixed contact bar 410 only until the movable contact bar 321 comes into contact with the restriction protrusion 414. Therefore, the movable contact 322 may move toward the fixed contact 420 to the extent that the movable contact 322 comes into contact with the fixed contact 420 without being excessively tightly attached to the fixed contact 420.

The restriction protrusion 414 is continuously connected to the second extension portion 412. The restriction protrusion 414 protrudes forward from one surface directed toward the internal space of the frame 100 or the movable contact 322, i.e., the front surface in the illustrated embodiment among the surfaces of the second extension portion 412.

The restriction protrusion 414 is positioned between the movable contact 322 and the arc runner support portion 413. In the illustrated embodiment, the restriction protrusion 414 is positioned above the movable contact 322 and positioned below the arc runner support portion 413.

When the movable contact 322 and the fixed contact 420 come into contact with each other as the movable contact part 320 rotates toward the fixed contact bar 410, one side directed toward the housing 500, among the sides of the movable contact part 320 based on the extension direction, i.e., the portion adjacent to the upper end in the illustrated embodiment comes into contact with the restriction protrusion 414. Therefore, the rotation angle of the movable contact part 320 is restricted, which may prevent the movable contact 322 and the fixed contact 420 from being excessively tightly attached to each other.

Therefore, in case that an abnormal current, such as an overcurrent, is conducted, the process of separating the movable contact 322 and the fixed contact 420 may be quickly performed.

The housing accommodation groove 415 accommodates a partial portion of the housing 500. The partial portion of the housing 500 accommodated in the housing accommodation groove 415 may be configured to press the fixed contact bar 410. Therefore, the coupled state between the housing 500 and the fixed contact bar 410 may be stably maintained.

The housing accommodation groove 415 is formed in the first extension portion 411. The housing accommodation groove 415 is formed at a part of an edge of the first extension portion 411 extending in the extension direction, i.e., a part of an edge extending in the forward/rearward direction in the illustrated embodiment. In the illustrated embodiment, the housing accommodation groove 415 is recessed radially inward at the edge positioned upward among the edges of the first extension portion 411 extending in the forward/rearward direction.

The housing accommodation groove 415 extends in the extension direction of the first extension portion 411, i.e., the forward/rearward direction in the illustrated embodiment. In this case, an extension length of the housing accommodation groove 415 may be shorter than an extension length of the first extension portion 411.

Therefore, a portion where the first extension portion 411 is in direct contact with the housing 500 may be accommodated in the housing accommodation groove 415 and provided to be in contact with and support the first extension portion 411.

To this end, the housing accommodation groove 415 may be formed in a shape corresponding to a partial portion of the housing 500 that faces the housing accommodation groove 415. In the illustrated embodiment, the housing accommodation groove 415 is formed to be surrounded by one surface extending to be inclined toward the inside of the first extension portion 411.

The housing accommodation groove 415 may be provided as a plurality of housing accommodation grooves 415. The plurality of housing accommodation grooves 415 may be respectively formed at different edges of the first extension portion 411. In the illustrated embodiment, the housing accommodation grooves 415 are respectively formed at the pair of edges positioned upward among the four edges of the first extension portion 411 extending in the forward/rearward direction.

The gas generation member accommodation groove 416 accommodates a partial portion of the gas generation member 430 coupled to the housing 500. The partial portion of the gas generation member 430 accommodated in the gas generation member accommodation groove 416 is configured to press the fixed contact bar 410. Therefore, the coupled state between the fixed contact bar 410 and the gas generation member 430 may be stably maintained.

The gas generation member accommodation groove 416 is formed in the second extension portion 412. The gas generation member accommodation groove 416 is formed at a part of an edge of the second extension portion 412 extending in the longitudinal direction, i.e., a part of an edge extending in the forward/rearward direction in the illustrated embodiment. In the illustrated embodiment, the gas generation member accommodation groove 416 is recessed radially inward in a part of the edge positioned upward among the edges of the second extension portion 412 extending in the forward/rearward direction.

The gas generation member accommodation groove 416 extends in the longitudinal direction of the second extension portion 412, i.e., the forward/rearward direction in the illustrated embodiment. That is, the gas generation member accommodation groove 416 may extend in the same direction as the housing accommodation groove 415.

An extension length of the gas generation member accommodation groove 416 may be determined depending on a thickness of the gas generation member 430. In this case, the extension length of the gas generation member accommodation groove 416 may be shorter than an extension length of the second extension portion 412. Therefore, the arc runner accommodation groove 417 may be formed in another part of the edge of the second extension portion 412.

The gas generation member accommodation groove 416 may be positioned adjacent to the arc runner accommodation groove 417. In the illustrated embodiment, the gas generation member accommodation groove 416 is positioned forward of the arc runner accommodation groove 417. A positional relationship between the gas generation member accommodation groove 416 and the arc runner accommodation groove 417 may change depending on a positional relationship between the gas generation member 4230 and the arc runner 440.

One component of the gas generation member 430, i.e., a gas generation arm 432 to be described below may be accommodated in the gas generation member accommodation groove 416. In this case, the gas generation arm 432 is disposed to cover an arc runner arm 444, which is accommodated in the arc runner accommodation groove 417, from the outside, i.e., from the front side in the illustrated embodiment.

In addition, the gas generation arm 432 accommodated in the gas generation member accommodation groove 416 presses one surface of the second extension portion 412, i.e., the upper surface in the illustrated embodiment that surrounds the gas generation member accommodation groove 416. Therefore, the coupled state between the gas generation member 430 and the fixed contact bar 410 may be stably maintained.

The gas generation member accommodation groove 416 may be formed in a shape corresponding to an end shape of the gas generation arm 432. In the illustrated embodiment, the gas generation member accommodation groove 416 is formed to be surrounded by one surface extending to be inclined toward the inside of the second extension portion 412.

The gas generation member accommodation groove 416 may be provided as a plurality of gas generation member accommodation grooves 416. The plurality of gas generation member accommodation grooves 416 may be respectively positioned at different edges of the second extension portion 412. In the illustrated embodiment, the gas generation member accommodation grooves 416 are respectively formed at the pair of edges positioned upward among the four edges of the second extension portion 412 extending in the forward/rearward direction.

The gas generation member accommodation groove 416 communicates with the arc runner accommodation groove 417.

The arc runner accommodation groove 417 accommodates a partial portion of the arc runner 440 coupled to the housing 500. The partial portion of the arc runner 440 accommodated in the arc runner accommodation groove 417 is configured to press the fixed contact bar 410. Therefore, the coupled state between the fixed contact bar 410 and the arc runner 440 may be stably maintained.

The arc runner accommodation groove 417 is formed in the second extension portion 412. The arc runner accommodation groove 417 is formed at a part of the edge of the second extension portion 412 extending in the longitudinal direction, i.e., a part of the edge extending in the forward/rearward direction in the illustrated embodiment. In the illustrated embodiment, the arc runner accommodation groove 417 is recessed radially inward in a part of the edge positioned upward among the edges of the second extension portion 412 extending in the forward/rearward direction.

The arc runner accommodation groove 417 extends in the longitudinal direction of the second extension portion 412, i.e., the forward/rearward direction in the illustrated embodiment. That is, the arc runner accommodation groove 417 may extend in the same direction as the housing accommodation groove 415 and the gas generation member accommodation groove 416.

An extension length of the arc runner accommodation groove 417 may be determined depending on a thickness of the arc runner arm 444 of the arc runner 440. In this case, the extension length of the arc runner accommodation groove 417 may be shorter than the extension length of the second extension portion 412. Therefore, both the arc runner accommodation groove 417 and the gas generation member accommodation groove 416 may be formed at the edge of the second extension portion 412.

The arc runner accommodation groove 417 may be positioned adjacent to the gas generation member accommodation groove 416 and communicate with the gas generation member accommodation groove 416. In the illustrated embodiment, the arc runner accommodation groove 417 is positioned rearward of the gas generation member accommodation groove 416.

A state in which the fixed contact bar 410 is coupled to other components of the fixed contact part 400 and the housing 500 will be described below in detail.

The fixed contact 420 comes into contact with or separates from the movable contact 322. The breaker 10 may conductively connect or block the external power source and the external load by the contact or separation.

The fixed contact 420 is coupled to the fixed contact bar 410. Specifically, the fixed contact 420 is coupled to one surface directed toward the movable contact 322, i.e., the front surface in the illustrated embodiment among the surfaces of the second extension portion 412. The fixed contact 420 is electrically connected to the fixed contact bar 410.

The fixed contact 420 may be made of an electrically conductive material. In the embodiment, like the fixed contact bar 410, the fixed contact 420 may be made of copper, aluminum, or a metallic material containing copper and aluminum.

The fixed contact 420 is positioned to be spaced apart from the restriction protrusion 414. In the illustrated embodiment, the fixed contact 420 is positioned below the restriction protrusion 414. When the fixed contact 420 comes into contact with the movable contact 322, the restriction protrusion 414 may come into contact with the movable contact bar 321.

Because the process in which the movable contact 322 and the fixed contact 420 come into contact with each other or separate from each other so that the breaker 10 conductively connects or blocks the external power source and the external load is a well-known technology, a detailed description thereof will be omitted.

The gas generation member 430 generates gas by chemically reacting with heat generated together with the arc. The generated gas increases pressure in the internal space of the frame 100. Therefore, a transfer force may be generated to allow the arc, which is generated by a pressure difference between the internal space of the frame 100 and the outside, to propagate toward the arc extinguishing member 200.

That is, the gas generation member 430 generates the gas to move the generated arc quickly to the arc extinguishing member 200.

In addition, the gas generated by the gas generation member 430 may also serve to cool the arc while exchanging heat with the arc. The arc may flow toward the arc extinguishing member 200 while being cooled by the generated gas.

Therefore, the generated arc is sufficiently cooled and extinguished by the arc extinguishing member 200, and then the arc may be discharged to the outside of the breaker 10. Therefore, it is possible to prevent damage to the internal configuration of the breaker 10 or the arc extinguishing member 200 caused by heat generated together with the arc.

The gas generation member 430 may be made of any material that may generate gas while chemically reacting with heat generated together with the arc. In the embodiment, the gas generation member 430 may be made of a thermoplastic synthetic resin material such as nylon. In the embodiment, the gas generation member 430 may generate gas, such as hydrogen or nitrogen, by reacting with the heat.

The gas generation member 430 is coupled to the fixed contact bar 410. Specifically, one end of the gas generation member 430 based on the height direction, i.e., the lower end in the illustrated embodiment is accommodated in the gas generation member accommodation groove 416, which is formed in the fixed contact bar 410, and supported by the fixed contact bar 410.

The gas generation member 430 is coupled to the arc runner 440. Specifically, the gas generation member 430 is accommodated in an accommodation space 446 provided in the arc runner 440. The sides of the gas generation member 430 based on a thickness direction, i.e., the front and rear sides in the illustrated embodiment are surrounded by the arc runner 440.

The gas generation member 430 is coupled to the housing 500. Specifically, the gas generation member 430 is coupled to the housing 500 with a first arc runner body 441 interposed therebetween, and the first arc runner body 441 positioned at a rear side of the arc runner 440. Therefore, the gas generation member 430 is at least partially exposed to the internal space of the frame 100.

That is, when viewed from the internal space of the frame 100 that accommodates the movable contact 322, one component (i.e., a third arc runner body 443 to be described below) of the arc runner 440, the gas generation member 430, and another component (i.e., the first arc runner body 441 to be described below) of the arc runner 440 are disposed sequentially.

Therefore, the gas generation member 430 may chemically react with the heat generated together with the arc, and the gas generation member 430 may effectively provide gas for providing a transfer force to the arc.

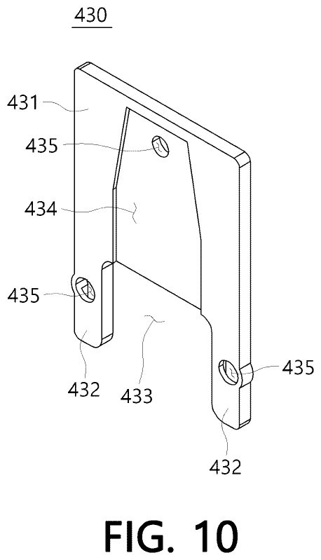

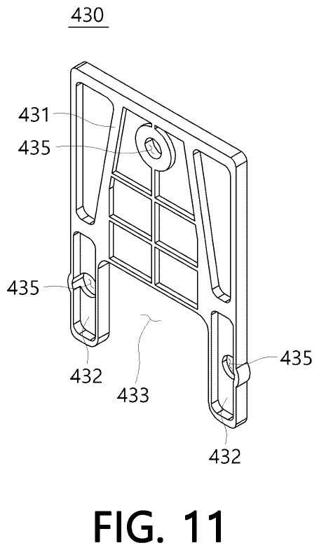

In the embodiment illustrated in FIGS. 10 to 11, the gas generation member 430 includes a gas generation body 431, the gas generation arm 432, an arc runner accommodation space 433, an arc runner accommodation groove 434, and a gas fastening hole 435.

The gas generation body 431 defines one configuration of the gas generation member 430. The gas generation body 431 is at least partially accommodated in the accommodation space 446 of the arc runner 440.

The gas generation body 431 is coupled to the arc runner 440 and the housing 500. The coupling is achieved as the fastening member 450 penetrates the gas fastening hole 435 formed in the gas generation body 431.

The gas generation body 431 may be formed in a shape corresponding to a shape of the accommodation space 446. In the illustrated embodiment, the gas generation body 431 is formed in a polygonal plate shape having a width in the leftward/rightward direction, a height in the upward/downward direction, and a thickness in the forward/rearward direction. In this case, a length of a width of the gas generation body 431, i.e., a length in the leftward/rightward direction may be longer than a length of a width of a second arc runner body 442 of the arc runner 440.

The gas generation body 431 is continuously connected to the gas generation arm 432.

The gas generation arm 432 defines another configuration of the gas generation member 430. The gas generation arm 432 extends to the outside of the gas generation body 431. Specifically, the gas generation arm 432 extends downward from one end of the gas generation body 431 based on the height direction, i.e., the lower end in the illustrated embodiment.

The gas generation arm 432 is coupled to the arc runner 440 and the housing 500. The coupling is achieved as the fastening member 450 penetrates the gas fastening hole 435 formed in the gas generation arm 432.

The gas generation arm 432 may be provided as a plurality of gas generation arms 432. The plurality of gas generation arms 432 may be disposed to be spaced apart from one another in the width direction of the gas generation body 431. In the illustrated embodiment, two gas generation arms 432 are provided and continuously connected to a left lower end and a right lower end of the gas generation body 431.

The gas generation arm 432 is supported by the fixed contact bar 410. Specifically, an end of the gas generation arm 432 based on the extension direction, i.e., the lower end in the illustrated embodiment is accommodated in the gas generation member accommodation groove 416, such that the gas generation arm 432 may be supported by the second extension portion 412.

In this case, the pair of gas generation arms 432 are disposed to face each other with the arc runner accommodation space 433 interposed therebetween.

The arc runner accommodation space 433 is a space in which the gas generation member 430 accommodates the arc runner 440. The arc runner accommodation space 433 may be defined as a space partially surrounded by the gas generation body 431 and the gas generation arm 432.

That is, in the illustrated embodiment, an upper side of the arc runner accommodation space 433 is surrounded by a lower side of the gas generation body 431. In addition, left and right sides of the arc runner accommodation space 433 are surrounded by the pair of gas generation arms 432. Another portion of the arc runner accommodation space 433, i.e., the lower side in the illustrated embodiment is formed to be opened, such that the second arc runner body 442 of the arc runner 440 may be inserted into the arc runner accommodation space 433.

The arc runner accommodation space 433 may be formed to correspond to a shape of the arc runner 440, specifically, the second arc runner body 442. In the illustrated embodiment, the arc runner accommodation space 433 is formed as a space having a quadrangular plate shape, and a lower side of the arc runner accommodation space 433 is opened.

The arc runner accommodation groove 434 may be defined as another space in which the gas generation member 430 accommodates the arc runner 440. The arc runner accommodation groove 434 partially accommodates the third arc runner body 443 of the arc runner 440 coupled to the gas generation member 430.

The arc runner accommodation groove 434 is formed in the gas generation body 431. Specifically, the arc runner accommodation groove 434 is recessed in one surface directed toward the internal space of the frame 100, i.e., the front surface in the illustrated embodiment among the surfaces of the gas generation body 431.

The arc runner accommodation groove 434 may be formed to correspond to a shape of the third arc runner body 443. In the illustrated embodiment, a lower side of the arc runner accommodation groove 434 is opened, and an upper side of the arc runner accommodation groove 434 is surrounded by the gas generation body 431. In addition, an extension length in the width direction of the upper side of the arc runner accommodation groove 434 is shorter than an extension length in the width direction of the lower side of the arc runner accommodation groove 434. Therefore, the arc runner accommodation groove 434 is understood as including a portion having a cross-sectional area that decreases in a direction from the lower side toward the upper side thereof.

The third arc runner body 443 inserted into the arc runner accommodation groove 434 may be supported by the gas generation body 431 that surrounds the arc runner accommodation groove 434. Therefore, the coupled state between the gas generation member 430 and the arc runner 440 may be stably maintained.

The gas fastening hole 435 is a space to which the fastening member 450 is coupled. The gas fastening hole 435 is formed through the gas generation member 430.

The gas fastening hole 435 is disposed to overlap an arc fastening hole 447 formed in the arc runner 440 and overlap a housing fastening hole 540 formed in the housing 500. That is, the fastening member 450 may penetrate the gas fastening hole 435 and the arc fastening hole 447 and be coupled to the housing fastening hole 540.

The gas fastening hole 435 may have any shape that may be penetrated by the fastening member 450. In the illustrated embodiment, the gas fastening hole 435 is formed as a space having a circular plate shape having a circular cross-section and having a thickness of the forward/rearward direction.

The gas fastening hole 435 may be provided as a plurality of gas fastening holes 435. The plurality of gas fastening holes 435 may be formed in the gas generation body 431 or the gas generation arm 432. In the illustrated embodiment, three gas fastening holes 435 are formed. In this case, any one gas fastening hole 435 may be positioned to be biased toward an upper side of the gas generation body 431. In addition, the remaining gas fastening holes 435 are formed in the pair of gas generation arms 432.

The number of gas fastening holes 435 and the method of disposing the gas fastening holes 435 may vary depending on the number of arc fastening holes 447, the number of housing fastening holes 540, the method of disposing the arc fastening holes 447, and the method of disposing the housing fastening holes 540.

Alternatively, the breaker 10 may be configured without the gas generation member 430. In the embodiment, the frame 100 or the housing 500 may be made of a material, which may generate gas, i.e., made of the same material as the above-mentioned gas generation member 430. That is, the frame 100 or the housing 500 may be configured to generate gas while chemically reacting with the heat generated together with the arc.

In the embodiment, it may be understood that the gas generated by the frame 100 or the housing 500 may cool the generated arc and allow the arc to flow toward the arc extinguishing member 200.

The arc runner 440 guides the generated arc toward the arc extinguishing member 200. The arc, which occurs as the fixed contact 420 and the movable contact 322 are separated from each other, may be quickly guided to the arc extinguishing member 200 by the arc runner 440.

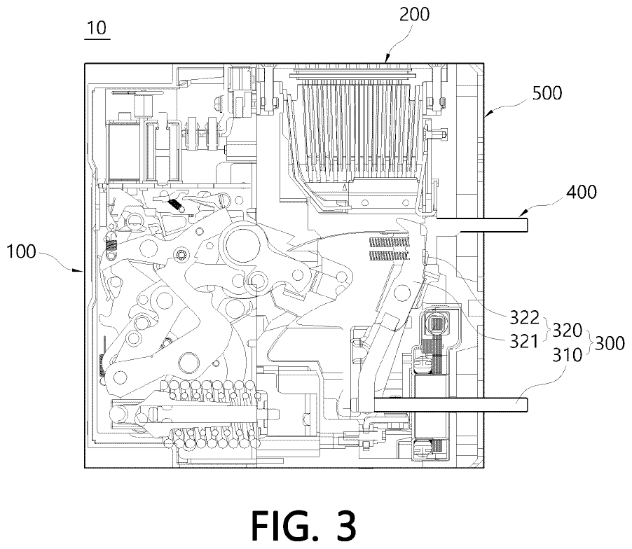

The arc runner 440 extends between the arc extinguishing member 200 and the fixed contact 420. That is, with reference back to FIG. 3, an upper end of the arc runner 440 is positioned adjacent to the arc extinguishing member 200, and a lower end of the arc runner 440 is positioned adjacent to the fixed contact 420.

Therefore, the arc generated on the fixed contact 420 may be extended and guided to the arc extinguishing member 200 along the arc runner 440.

The arc runner 440 is coupled to the fixed contact bar 410. Some components of the arc runner 440 may be accommodated in the arc runner accommodation groove 417 and supported by the fixed contact bar 410. In addition, other components of the arc runner 440 may be seated and supported on the arc runner support portion 413.

The arc runner 440 is coupled to the gas generation member 430. In this case, the arc runner 440 at least partially surrounds the gas generation member 430 and is coupled to the gas generation member 430. As described above, the arc runner 440 may accommodate a part of the gas generation member 430.

The arc runner 440 is coupled to the housing 500. The arc runner 440 may be disposed to overlap the gas generation member 430 and coupled to the housing 500 by the fastening member 450.

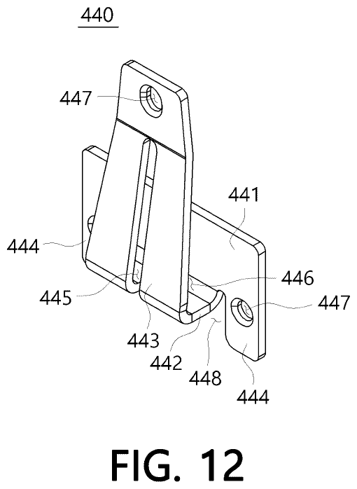

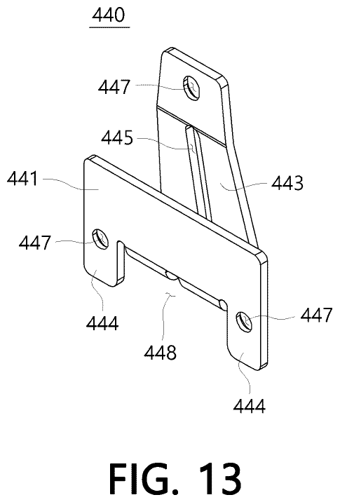

In the embodiment illustrated in FIGS. 12 to 13, the arc runner 440 includes the first arc runner body 441, the second arc runner body 442, the third arc runner body 443, the arc runner arm 444, a cut-out groove 445, the accommodation space 446, the arc fastening hole 447, and a contact bar accommodation space 448.

The first arc runner body 441 constitutes a part of an external shape of the arc runner 440. The first arc runner body 441 defines one configuration in which the arc runner 440 is coupled to the housing 500.

The first arc runner body 441 is disposed to overlap the gas generation member 430. Specifically, the first arc runner body 441 is disposed to overlap the gas generation body 431 accommodated in the accommodation space 446.

The first arc runner body 441 is positioned to face the third arc runner body 443. In the illustrated embodiment, the first arc runner body 441 faces the third arc runner body 443 with the accommodation space 446 interposed therebetween.

The first arc runner body 441 may have a shape corresponding to a shape of the contact bar coupling portion 530 of the housing 500. In the illustrated embodiment, the first arc runner body 441 is formed in a quadrangular plate shape having a width in the leftward/rightward direction, a height in the upward/downward direction, and a thickness in the forward/rearward direction.

One end of the first arc runner body 441 based on the height direction, i.e., the lower end in the illustrated embodiment is continuously connected to the second arc runner body 442.

The second arc runner body 442 defines another part of the external shape of the arc runner 440. The second arc runner body 442 is a portion where the arc runner 440 is seated on the arc runner support portion 413.

The second arc runner body 442 is continuously connected to the first arc runner body 441 and the third arc runner body 443. In this case, the second arc runner body 442 may be continuously connected to the first arc runner body 441 and the third arc runner body 443 while having a predetermined angle.

In the illustrated embodiment, the second arc runner body 442 is continuously connected to the first arc runner body 441 while having a predetermined angle with respect to the first arc runner body 441. In the embodiment, the predetermined angle may be an acute angle, a right angle, or an obtuse angle. In addition, the second arc runner body 442 is continuously connected to the third arc runner body 443 while having a right angle or an acute angle with respect to the third arc runner body 443.

The second arc runner body 442 may have any shape that may connect the first and third arc runner bodies 441 and 443 and be supported by the arc runner support portion 413. In the illustrated embodiment, the second arc runner body 442 extends in the forward/rearward direction so as to be convex downward, i.e., toward one side directed toward the fixed contact bar 410.

The third arc runner body 443 defines still another part of the external shape of the arc runner 440. The third arc runner body 443 constitutes one configuration in which the arc runner 440 is coupled to the gas generation member 430.

Specifically, the third arc runner body 443 is accommodated in the arc runner accommodation groove 434 of the gas generation member 430. The third arc runner body 443 may press one surface, i.e., the front surface of the gas generation body 431 in which the arc runner accommodation groove 434 is formed.

Therefore, the coupled state between the gas generation member 430 and the arc runner 440 may be stably maintained.

The third arc runner body 443 is continuously connected to the second arc runner body 442. As described above, the third arc runner body 443 may extend while having a right angle or an acute angle with respect to the second arc runner body 442.

The third arc runner body 443 extends in the same direction as the first arc runner body 441, i.e., extends in the upward/downward direction in the illustrated embodiment. In this case, the third arc runner body 443 may extend to be inclined in a direction toward the first arc runner body 441, i.e., toward the rear side in the illustrated embodiment.

Therefore, it may be understood that a distance between the third arc runner body 443 and the first arc runner body 441 decreases in the direction from the lower side toward the upper side of the third arc runner body 443.

One end of the third arc runner body 443 based on the extension direction, i.e., the upper end in the illustrated embodiment may extend in parallel with a surface of the gas generation body 431. Therefore, one end of the third arc runner body 443 may be in contact with the surface of the gas generation body 431, which surrounds the arc runner accommodation groove 434, and support the gas generation member 430.

The arc runner arm 444 defines yet another part of the external shape of the arc runner 440. The arc runner arm 444 defines one configuration in which the arc runner 440 is coupled to the gas generation member 430 and the housing 500.

The arc runner arm 444 is continuously connected to the first arc runner body 441. The arc runner arm 444 extends in the height direction of the first arc runner body 441, i.e., the upward/downward direction in the illustrated embodiment.

The arc runner arm 444 may be provided as a plurality of arc runner arms 444. The plurality of arc runner arms 444 may be disposed to be spaced apart from one another in the width direction of the first arc runner body 441. In the illustrated embodiment, the arc runner arm 444 is provided as a pair of arc runner arms 444 respectively positioned at a lower left end and a lower right end of the first arc runner body 441. A space formed between the pair of arc runner arms 444 is defined as the contact bar accommodation space 448.

The arc runner arm 444 is supported by the fixed contact bar 410. Specifically, the end of the arc runner arm 444 based on the extension direction, i.e., the lower end in the illustrated embodiment may be accommodated in the arc runner accommodation groove 417 and supported by the second extension portion 412.

Therefore, the coupled state between the arc runner 440 and the fixed contact bar 410 may be stably maintained.

The cut-out groove 445 defines one passageway through which the gas generated by the gas generation member 430 leaks to the internal space of the frame 100. The cut-out groove 445 is formed through the inside of the arc runner 440 and allows the accommodation space 446 and the internal space of the frame 100 to communicate with each other.

Of course, as described below, the accommodation space 446 also communicates with the internal space of the frame 100 in the width direction of the arc runner 440, i.e., the leftward/rightward direction in the illustrated embodiment. Therefore, it can be seen that the cut-out groove 445 defines an additional route through which the gas generated by the gas generation member 430 more quickly flows toward the arc.

The cut-out groove 445 is formed in a direction toward the internal space of the frame 100 among the components of the arc runner 440. In the illustrated embodiment, the cut-out groove 445 is formed in the second arc runner body 442 and the third arc runner body 443. In other words, the cut-out groove 445 is not formed in the first arc runner body 441 positioned in the direction toward the housing 500.

Therefore, the gas generated by the gas generation member 430 may concentratedly flow toward the internal space of the frame 100, i.e., in a direction in which the arc is generated without flowing to the housing 500.

The cut-out groove 445 may extend in the extension directions of the second arc runner body 442 and the third arc runner body 443. In the illustrated embodiment, the cut-out groove 445 extends from a rear end of the second arc runner body 442 to a position adjacent to the upper end of the third arc runner body 443.

The accommodation space 446 is a space in which the arc runner 440 accommodates the gas generation body 431. The accommodation space 446 may be at least partially opened and communicate with the internal space of the frame 100. The gas, which is generated by the gas generation body 431 accommodated in the accommodation space 446, may flow to the internal space of the frame 100.

The accommodation space 446 is defined by being partially surrounded by the first to third arc runner bodies 441, 442, and 443. In the illustrated embodiment, a rear side of the accommodation space 446 is surrounded by the first arc runner body 441, and a lower side of the accommodation space 446 is surrounded by the second arc runner body 442. In addition, a front side of the accommodation space 446 is surrounded by the third arc runner body 443.

Therefore, a front side of the gas generation body 431, which is accommodated in the accommodation space 446, may be supported by the third arc runner body 443, a lower side of the gas generation body 431 may be supported by the second arc runner body 442, and a rear side of the gas generation body 431 may be supported by the first arc runner body 441.

The sides of the accommodation space 446 based on the width direction, i.e., the left and right sides in the illustrated embodiment are opened. In addition, the cut-out groove 445 is formed in the second and third arc runner bodies 442 and 443 that surround the front and lower sides of the accommodation space 446, and the cut-out groove 445 allows the accommodation space 446 to communicate with the internal space of the frame 100.

Therefore, the accommodation space 446 communicates with the internal space of the frame 100 in the plurality of directions except for the direction (i.e., the rear side) toward the housing 500. Therefore, the gas, which is generated by the gas generation body 431 accommodated in the accommodation space 446, may smoothly flow toward the internal space of the frame 100.

The accommodation space 446 may have any shape that may accommodate the gas generation body 431. In the illustrated embodiment, the accommodation space 446 is a space having a three-dimensional shape having a cross-sectional area that decreases upward.

The arc fastening hole 447 is a space to which the fastening member 450 is coupled. The arc fastening hole 447 is formed through the arc runner 440.

The arc fastening hole 447 is disposed to overlap the gas fastening hole 435 and the housing fastening hole 540. That is, the fastening member 450 may be penetratively coupled to the gas fastening hole 435, the arc fastening hole 447, and the housing fastening hole 540.

The arc fastening hole 447 may have any shape that may be penetrated by the fastening member 450. In the illustrated embodiment, the arc fastening hole 447 is formed as a space having a circular plate shape having a circular cross-section and having a thickness of the forward/rearward direction.

The arc fastening hole 447 may be provided as a plurality of arc fastening holes 447. The plurality of arc fastening holes 447 may be formed in the arc runner bodies 441, 442, and 443 or the arc runner arm 444. In the illustrated embodiment, three arc fastening holes 447 are formed. In this case, any one arc fastening hole 447 is positioned adjacent to the upper end of the third arc runner body 443. In addition, the remaining arc fastening holes 447 are formed in the pair of arc runner arms 444.

The number of arc fastening holes 447 and the method of disposing the arc fastening holes 447 may vary depending on the number of gas fastening holes 435, the number of housing fastening holes 540, the method of disposing the gas fastening holes 435, and the method of disposing the housing fastening holes 540.

The contact bar accommodation space 448 constitutes a partial portion where the fixed contact bar 410 is coupled to the arc runner 440.

Among the sides of the contact bar accommodation space 448, one side directed toward the fixed contact bar 410, i.e., the lower side in the illustrated embodiment is opened, such that the fixed contact bar 410 may enter the contact bar accommodation space 448. The second arc runner body 442 may be supported by the arc runner support portion 413 of the fixed contact bar 410 accommodated in the contact bar accommodation space 448.

The contact bar accommodation space 448 may be defined as a space surrounded by the first arc runner body 441, the second arc runner body 442, and the arc runner arm 444. In the illustrated embodiment, one side of the contact bar accommodation space 448 based on the height direction, i.e., the upper side is surrounded by the first arc runner body 441 or the second arc runner body 442.

In addition, the sides of the contact bar accommodation space 448 based on the width direction, i.e., the left and right sides in the illustrated embodiment are surrounded by the pair of arc runner arms 444. As described above, the lower side of the contact bar accommodation space 448 is opened, such that a passageway, which accommodates the fixed contact bar 410, may be formed.

The fixed contact bar 410 accommodated in the contact bar accommodation space 448 is surrounded by the first arc runner body 441, the second arc runner body 442, and the pair of arc runner arms 444. Therefore, the coupled state between the fixed contact bar 410 and the arc runner 440 may be stably maintained.

The fastening member 450 couples the gas generation member 430, the arc runner 440, and the housing 500. The fastening member 450 penetrates the gas generation member 430 and the arc runner 440 and is coupled to the housing 500.

Specifically, the fastening member 450 penetrates the gas fastening hole 435 and the arc fastening hole 447 and is inserted into the housing fastening hole 540. To this end, as described above, the gas fastening hole 435, the arc fastening hole 447, and the housing fastening hole 540 are disposed to overlap one another in the insertion direction of the fastening member 450, i.e., the forward/rearward direction in the illustrated embodiment.

The fastening member 450 may have any shape that may couple the gas generation member 430, the arc runner 440, and the housing 500 to one another. In the embodiment, the fastening member 450 may be provided in the form of a screw member such as a bolt.

The fastening member 450 may be provided as a plurality of fastening members 450. The plurality of fastening members 450 may be coupled to the plurality of gas fastening holes 435, the plurality of arc fastening holes 447, and the plurality of housing fastening holes 540. In the illustrated embodiment, three fastening members 450 may be provided and coupled to the three gas fastening holes 435, the three arc fastening holes 447, and the three housing fastening holes 540.

The housing 500 is coupled to and supports the fixed contact part 400. The housing 500 is coupled to the frame 100 while covering the space formed in the frame 100. Therefore, some components of the fixed contact part 400, i.e., some components of the fixed contact bar 410, the fixed contact 420, the gas generation member 430, the arc runner 440, and the fastening member 450 may be accommodated in the space formed in the frame 100.

The housing 500 is coupled to the frame 100. The housing 500 is coupled to one side of the frame 100 based on the longitudinal direction, i.e., the rear side in the illustrated embodiment.

In the embodiment, the housing 500 may be coupled to the frame 100 while sealing the internal space of the frame 100. Therefore, the arc, which occurs in the internal space of the frame 100, may be extinguished while passing through the arc extinguishing member 200 and then discharged to the outside. In addition, the generated gas, which is generated by heat generated together with the arc, does not arbitrarily leak to the outside, such that the pressure in the internal space of the frame 100 may be increased.

The housing 500 is coupled to the terminal 310 of the conduction part 300. The terminal 310 may be supported by the housing 500 and exposed to the outside. The terminal 310 may be penetratively coupled to the housing 500.

The housing 500 is coupled to the fixed contact part 400. The fixed contact bar 410 may be supported by the housing 500 and exposed to the outside. The fixed contact bar 410 may be penetratively coupled to the housing 500.

In addition, the housing 500 is coupled to other components of the fixed contact part 400, i.e., the gas generation member 430 and the arc runner 440. As described above, the coupling is achieved by the fastening member 450.

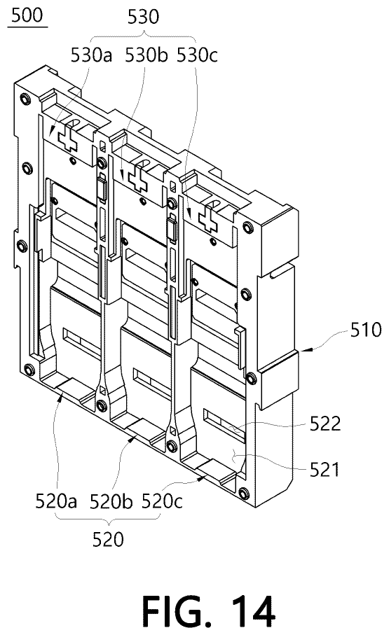

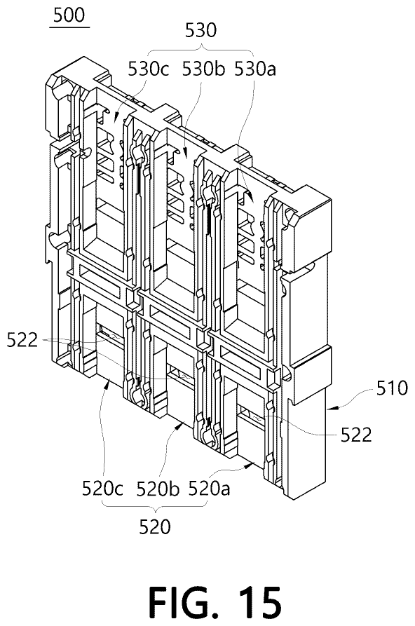

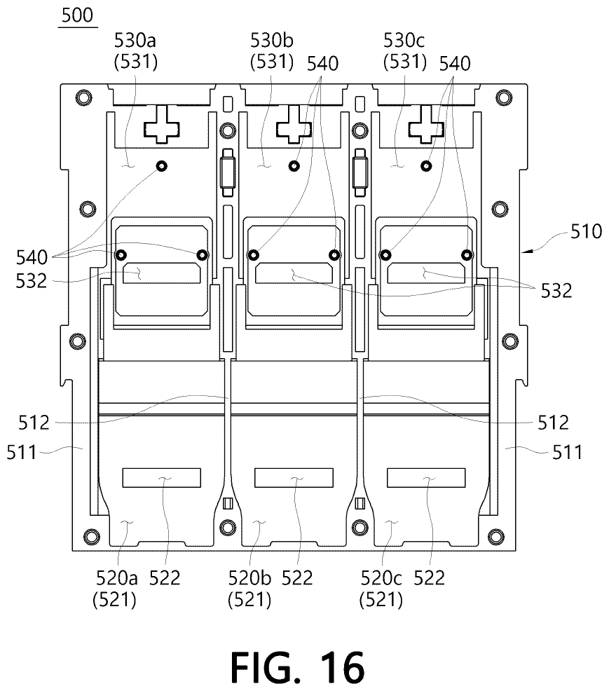

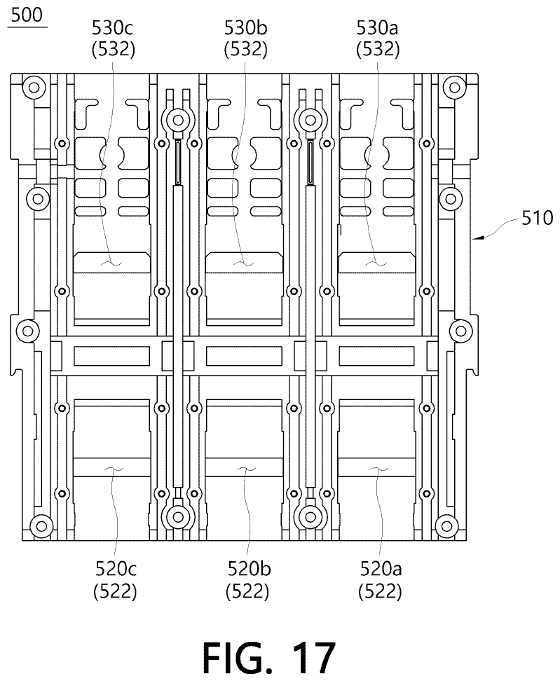

In the embodiment illustrated in FIGS. 14 to 17, the housing 500 includes the contact housing body 510, the terminal coupling portion 520, the contact bar coupling portion 530, and the housing fastening hole 540.

The contact housing body 510 defines an external shape of the housing 500. The contact housing body 510 is coupled to the frame 100 while covering the space formed in the frame 100.

The contact housing body 510 has the terminal coupling portion 520, the contact bar coupling portion 530, and the housing fastening hole 540. The contact housing body 510 may be coupled to the terminal 310 and the fixed contact part 400 and support the terminal 310 and the fixed contact part 400.

The contact housing body 510 may have any shape that may be coupled to the frame 100, coupled to the conduction part 300 and the fixed contact part 400, and configured to support the conduction part 300 and the fixed contact part 400. In the illustrated embodiment, the contact housing body 510 has a polygonal column shape having a height in the upward/downward direction, a width in the leftward/rightward direction, and a thickness in the forward/rearward direction.

In the illustrated embodiment, the contact housing body 510 includes an outer wall 511 and an inner wall 512.

The outer wall 511 defines a part of an outer periphery of the contact housing body 510. In the illustrated embodiment, the outer wall 511 is positioned at one side directed toward the frame 100, i.e., the front side among the sides of the contact housing body 510.

The outer wall 511 may be provided as a plurality of outer walls 511. The plurality of outer walls 511 may define the outer periphery based on the width direction of one side of the contact housing body 510. In the illustrated embodiment, two outer walls 511 are formed to respectively form left and right outer peripheries of the contact housing body 510. The outer wall 511 extends in the height direction of the contact housing body 510, i.e., the upward/downward direction in the illustrated embodiment.

The pair of outer walls 511 are disposed to face each other with the terminal coupling portion 520 and the contact bar coupling portion 530 interposed therebetween. That is, the terminal coupling portion 520 and the contact bar coupling portion 530 are positioned between the pair of outer walls 511.

The outer wall 511 partially surrounds the terminal coupling portion 520 and the contact bar coupling portion 530 in the width direction. In the illustrated embodiment, the outer wall 511 positioned at the left side surrounds a first terminal coupling portion 520a and a first contact bar coupling portion 530a, which are positioned at the left side, from the outside, i.e., the left side. In addition, the outer wall 511 positioned at the right side surrounds a third terminal coupling portion 520c and a third contact bar coupling portion 530c, which are positioned at the right side, from the outside, i.e., the right side.

The inner wall 512 is positioned between the pair of outer walls 511.

The inner wall 512 divides the inside of the contact housing body 510, i.e., the space between the pair of outer walls 511 into a plurality of spaces. The plurality of spaces separated by the inner wall 512 may include a plurality of terminal coupling portions 520 and a plurality of contact bar coupling portions 530.

The inner wall 512 extends in the same direction as the outer wall 511, i.e., the upward/downward direction in the illustrated embodiment. The inner wall 512 is disposed to be spaced apart from the outer wall 511 in the width direction of the contact housing body 510, i.e., the leftward/rightward direction in the illustrated embodiment.

The inner wall 512 may be provided as a plurality of inner walls 512. The plurality of inner walls 512 may be disposed to be spaced apart from one another in the width direction of the contact housing body 510. Therefore, the plurality of spaces may be defined between the plurality of outer walls 511 and the plurality of inner walls 512.

In the illustrated embodiment, two inner walls 512 are disposed and spaced apart from each other in the leftward/rightward direction. Therefore, the space between the pair of outer walls 511 may be divided into three small spaces.

The terminal coupling portion 520 is coupled to the terminal 310 of the conduction part 300. The terminal 310 may be coupled to the terminal coupling portion 520 and supported by the housing 500.

The terminal coupling portion 520 is formed on the contact housing body 510. In this case, the terminal coupling portion 520 may be positioned to be biased toward one side of the contact housing body 510 based on the height direction. In the illustrated embodiment, the terminal coupling portion 520 is positioned to be biased toward a lower side of the contact housing body 510. The position of the terminal coupling portion 520 may vary depending on the position of the terminal 310.

The terminal coupling portion 520 may be provided as a plurality of terminal coupling portions 520. The plurality of terminal coupling portions 520 may include some of the spaces separated by the plurality of outer walls 511 and the plurality of inner walls 512. In the illustrated embodiment, three terminal coupling portions 520 are provided and include the first terminal coupling portion 520a, a second terminal coupling portion 520b, and the third terminal coupling portion 520c.

The first terminal coupling portion 520a is positioned between the outer wall 511 and the inner wall 512 positioned to be biased toward the left side. The first terminal coupling portion 520a is coupled to the terminal 310 provided in the first conduction part 300a.

The second terminal coupling portion 520b is positioned between the pair of inner walls 512 that face each other. The second terminal coupling portion 520b is coupled to the terminal 310 provided in the second conduction part 300b.

The third terminal coupling portion 520c is positioned between the outer wall 511 and the inner wall 512 positioned to be biased toward the right side. The third terminal coupling portion 520c is coupled to the terminal 310 provided in the third conduction part 300c.

In the illustrated embodiment, the terminal coupling portion 520 includes a terminal accommodation space 521 and the terminal through-hole 522.

The terminal accommodation space 521 is a space that accommodates the terminal 310. The terminal accommodation space 521 accommodates a part, which is biased toward one end of the terminal 310 based on the extension direction, i.e., the rear portion in the illustrated embodiment.

The terminal accommodation space 521 communicates with the terminal through-hole 522.

The terminal through-hole 522 defines a passageway exposed to the outside. The terminal 310 may be penetratively coupled to the terminal through-hole 522.

The terminal through-hole 522 is formed through the contact housing body 510. In the illustrated embodiment, the terminal through-hole 522 is penetratively formed in the extension direction of the terminal 310, i.e., the forward/rearward direction.

The terminal through-hole 522 may be formed to correspond to a cross-sectional shape of the terminal 310. In the illustrated embodiment, the terminal through-hole 522 is formed to have a quadrangular cross-section in which a width in the leftward/rightward direction is larger than a height of the upward/downward direction.

The contact bar coupling portion 530 is coupled to the fixed contact part 400. The fixed contact part 400 may be coupled to and supported by the housing 500 by means of the contact bar coupling portion 530.

As described above, in the breaker 10 according to the embodiment of the present disclosure, the components of the fixed contact part 400 and the housing 500 may be easily coupled. In addition, the coupled state between the fixed contact part 400 and the housing 500 may be stably maintained. This configuration will be described in detail below.

The contact bar coupling portion 530 is formed on the contact housing body 510. In this case, the contact bar coupling portion 530 may be positioned to be biased toward the other side of the contact housing body 510 based on the height direction. In the illustrated embodiment, the contact bar coupling portion 530 is positioned to be biased toward an upper side of the contact housing body 510. The position of the contact bar coupling portion 530 may vary depending on the position of the fixed contact part 400.

That is, it may be understood that the contact bar coupling portion 530 is disposed to be spaced apart from the terminal coupling portion 520 so as to be opposite to the terminal coupling portion 520.

The contact bar coupling portion 530 may be provided as a plurality of contact bar coupling portions 530. The plurality of contact bar coupling portions 530 may include some of the other spaces separated by the plurality of outer walls 511 and the plurality of inner walls 512. In the illustrated embodiment, three contact bar coupling portions 530 are provided and include the first contact bar coupling portion 530a, a second contact bar coupling portion 530b, and the third contact bar coupling portion 530c.

The first contact bar coupling portion 530a is positioned between the outer wall 511 and the inner wall 512 positioned to be biased toward the left side. The first contact bar coupling portion 530a is coupled to the first fixed contact part 400a.

The second contact bar coupling portion 530b is positioned between the pair of inner walls 512 that face each other. The second contact bar coupling portion 530b is coupled to the second fixed contact part 400b.

The third contact bar coupling portion 530c is positioned between the outer wall 511 and the inner wall 512 positioned to be biased toward the right side. The third contact bar coupling portion 530c is coupled to the third fixed contact part 400c.

In the illustrated embodiment, the contact bar coupling portion 530 includes a contact bar accommodation space 531 and the contact bar through-hole 532.

The contact bar accommodation space 531 is a space that accommodates the fixed contact bar 410. As described above, the fixed contact bar 410 includes the first extension portion 411 extending in one direction (i.e., the forward/rearward direction), and the second extension portion 412 continuously connected to the first extension portion 411 and extending in the other direction (i.e., the upward/downward direction).

The contact bar accommodation space 531 may accommodate a part of the first extension portion 411 and the second extension portion 412. In the illustrated embodiment, the contact bar accommodation space 531 accommodates the second extension portion 412 and a part of the first extension portion 411 positioned adjacent to the second extension portion 412.

In this case, the second extension portion 412 may be in contact with the surface of the contact housing body 510, i.e., the front surface in the illustrated embodiment that surrounds the rear side of the contact bar accommodation space 531. Therefore, the fixed contact bar 410 may be supported by the contact housing body 510 and prevented from arbitrarily swaying or arbitrarily separating.

The contact bar accommodation space 531 communicates with the contact bar through-hole 532.

The contact bar through-hole 532 defines a passageway through which the first extension portion 411 of the fixed contact bar 410 is exposed to the outside. The first extension portion 411 may be penetratively coupled to the contact bar through-hole 532.

The contact bar through-hole 532 is formed through the contact housing body 510. In the illustrated embodiment, the contact bar through-hole 532 is penetratively formed in the extension direction of the first extension portion 411, i.e., the forward/rearward direction.

The contact bar through-hole 532 may be formed to correspond to a cross-sectional shape of the first extension portion 411. In the illustrated embodiment, the contact bar through-hole 532 is formed to have a quadrangular cross-section in which a width in the leftward/rightward direction is larger than a height of the upward/downward direction.

The housing fastening hole 540 is a space to which the fastening member 450 is coupled. The housing fastening hole 540 is formed through the contact housing body 510. Alternatively, the housing fastening hole 540 may be recessed in one surface directed toward the frame 100, i.e., the front surface in the illustrated embodiment among the surfaces of the contact housing body 510.

The housing fastening hole 540 is disposed to overlap the gas fastening hole 435 and the arc fastening hole 447. That is, the fastening member 450 may be coupled to the gas fastening hole 435, the arc fastening hole 447, and the housing fastening hole 540. In the embodiment, the fastening member 450 may penetrate the gas fastening hole 435 and the arc fastening hole 447 and be inserted into or penetratively coupled to the housing fastening hole 540.

The housing fastening hole 540 may have any shape that may be coupled to the fastening member 450. In the illustrated embodiment, the housing fastening hole 540 is formed as a space having a circular plate shape having a circular cross-section and having a thickness of the forward/rearward direction.

The housing fastening hole 540 may be provided as a plurality of housing fastening holes 540. The plurality of housing fastening holes 540 may be disposed to be spaced apart from one another and each formed through or recessed in one surface of the contact housing body 510. In the illustrated embodiment, three housing fastening holes 540 are positioned to be biased toward the upper, left, and right sides of the contact bar coupling portion 530.

The number of housing fastening holes 540 and the method of disposing the housing fastening holes 540 may vary depending on the number of gas fastening holes 435, the number of arc fastening holes 447, the method of disposing the gas fastening holes 435, and the method of disposing the arc fastening holes 447.

### 4. Description of Process of Manufacturing Breaker 10 and State of Breaker 10 According to Embodiment of Present Disclosure

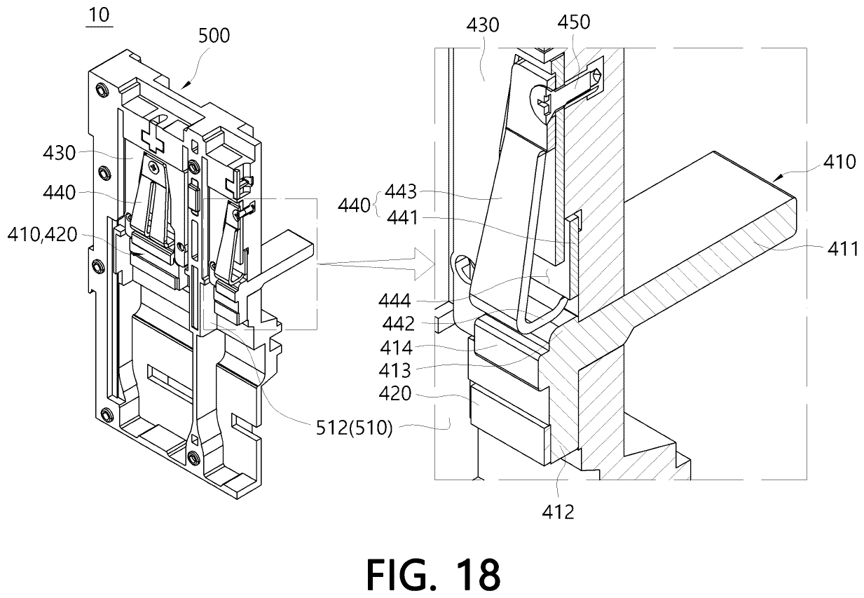

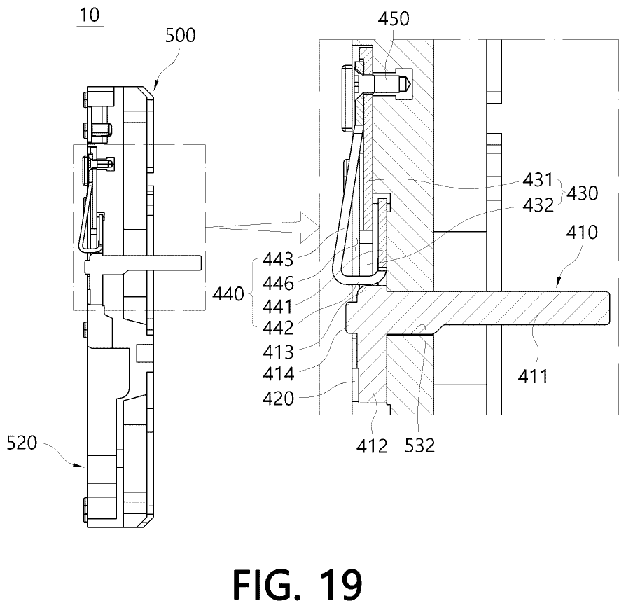

FIGS. 18 to 20 illustrate an example of a state in which the fixed contact part 400 and the housing 500 provided in the breaker 10 according to the embodiment of the present disclosure are assembled.

In the breaker 10 according to the embodiment of the present disclosure, the fixed contact part 400 and the housing 500 may be easily coupled. In addition, in the breaker 10 according to the embodiment of the present disclosure, the coupled state between the fixed contact part 400 and the housing 500 may be stably maintained.

First, a process of coupling the fixed contact part 400 and the housing 500 provided in the breaker 10 according to the embodiment of the present disclosure will be described below.

First, the fixed contact bar 410 may be coupled to the housing 500 first, and then the gas generation member 430 and the arc runner 440 may be coupled to the housing 500 later. Alternatively, the gas generation member 430 and the arc runner 440 may be coupled to the housing 500 first, and then the fixed contact bar 410 may be coupled to the housing 500.

The fixed contact bar 410 is coupled to the housing 500. The first extension portion 411 of the fixed contact bar 410 is penetratively coupled to the contact bar through-hole 532, and the second extension portion 412 is accommodated in the contact bar accommodation space 531.

Next, the gas generation member 430 and the arc runner 440 are coupled to the housing 500. In the embodiment, the gas generation member 430 may be disposed in the housing 500 first, and then the arc runner 440 may be coupled to the gas generation member 430 and disposed in the housing 500.

Alternatively, the process of coupling the gas generation member 430 and the arc runner 440 may be performed first, and then the process of disposing the gas generation member 430 and the arc runner 440 in the housing 500 may be performed.

In this case, the gas fastening hole 435, the arc fastening hole 447, and the housing fastening hole 540 may be disposed to overlap in a coupling direction of the fixed contact bar 410, i.e., the forward/rearward direction in the illustrated embodiment.

The fastening member 450 is coupled to the gas fastening hole 435, the arc fastening hole 447, and the housing fastening hole 540. In this case, the gas fastening hole 435 is provided as a plurality of gas fastening holes 435, the arc fastening hole 447 is provided as a plurality of arc fastening holes 447, and the housing fastening hole 540 is provided as a plurality of housing fastening holes 540, such that the gas generation member 430, the arc runner 440, and the housing 500 may be stably coupled by the plurality of fastening members 450.

Simultaneously, the gas generation member 430 and the arc runner 440 coupled to the housing 500 may support the fixed contact bar 410 in the height direction, i.e., at the upper side in the illustrated embodiment. Therefore, the fixed contact bar 410 may also be stably coupled to the housing 500.

Therefore, according to the embodiment of the present disclosure, the fixed contact bar 410 may be coupled to the housing 500 so as to be partially exposed to the outside of the breaker 10 only by the process of inserting the fixed contact bar 410 into the contact bar through-hole 532.

In addition, other components of the fixed contact part 400 and the fixed contact bar 410 are coupled to the housing 500 so as to support one another. Therefore, the coupled state between the components of the fixed contact part 400 and the coupled state between the fixed contact part 400 and the housing 500 may be stably maintained.

Hereinafter, a coupling relationship between the fixed contact part 400 and the housing 500 will be described with reference to FIGS. 18 to 20.

First, the first extension portion 411 penetrates the contact bar through-hole 532, and one side of the fixed contact bar 410 based on the extension direction, i.e., the rear end in the illustrated embodiment is exposed to the outside of the housing 500. In addition, the second extension portion 412 is accommodated in the contact bar accommodation space 531 and brought into contact with and supported by one surface of the contact housing body 510, i.e., the front surface in the illustrated embodiment that surrounds the contact bar accommodation space 531.

In this case, it may be understood that the fixed contact 420 is kept coupled to the front surface of the second extension portion 412.

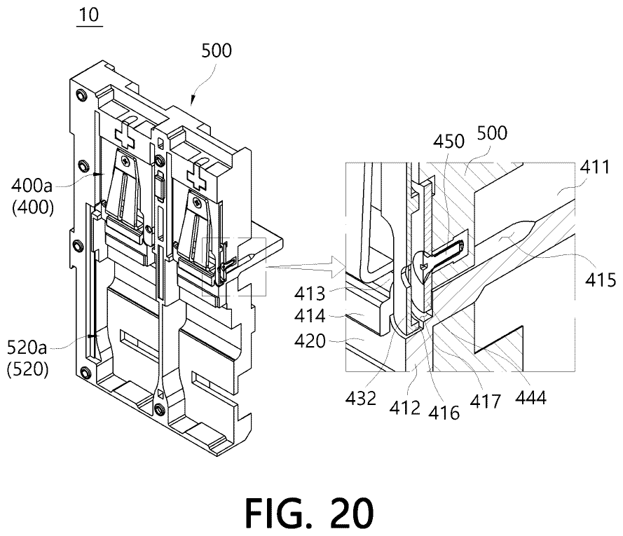

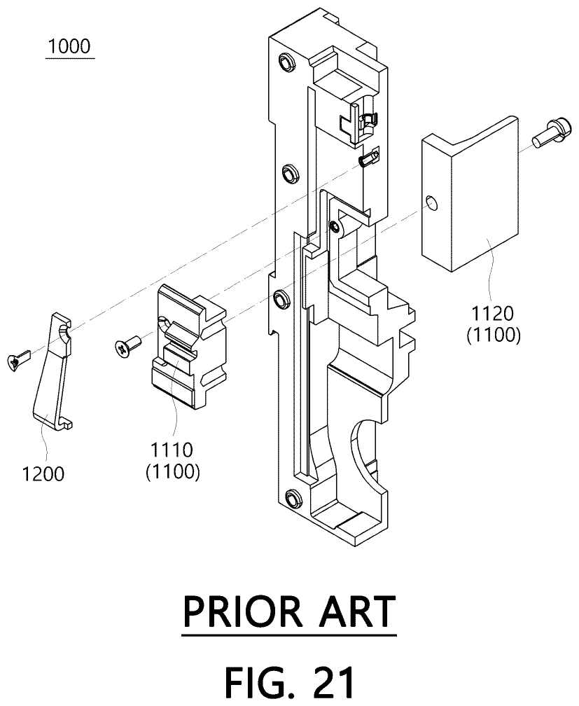

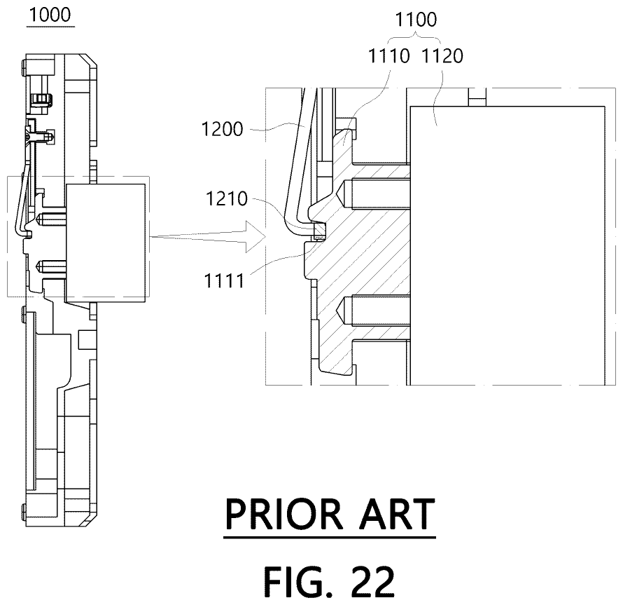

In addition, the contact housing body 510 is partially accommodated in the housing accommodation groove 415 formed at an upper edge of the first extension portion 411 (see FIG. 20). The portion of the contact housing body 510 supports the first extension portion 411 from above.

In addition, a lower end of the gas generation arm 432 is accommodated in the gas generation member accommodation groove 416 formed at an upper edge of the second extension portion 412. The gas generation arm 432 supports the second extension portion 412 from above.

Furthermore, a lower end of the arc runner arm 444 is accommodated in the arc runner accommodation groove 417 formed at the upper edge of the second extension portion 412. The arc runner arm 444 may also support the second extension portion 412 from above.

Therefore, the fixed contact bar 410 may be stably coupled to the gas generation member 430, the arc runner 440, and the housing 500.

In addition, the gas generation member 430 is accommodated in the accommodation space 446 of the arc runner 440. Therefore, the sides of the gas generation member 430 based on the thickness direction, i.e., the front and rear sides are surrounded by the first arc runner body 441 and the third arc runner body 443.

In the embodiment, the front and rear surfaces of the gas generation member 430 may be pressed by being brought into contact with the first arc runner body 441 and the third arc runner body 443. Therefore, the gas generation member 430 does not separate from the front or rear side.

A lower end of the gas generation body 431 is supported by the second arc runner body 442. The gas generation arm 432 extending from the lower side of the gas generation body 431 prevents the gas generation member 430 from being separated from the accommodation space 446 in the width direction, i.e., the leftward/rightward direction in the illustrated embodiment. The fastening member 450 coupled to the gas fastening hole 435 positioned upward prevents the gas generation member 430 from being separated upward.

Therefore, the gas generation member 430 and the arc runner 440 may be stably coupled.

The gas generation arm 432 is accommodated in the gas generation member accommodation groove 416 formed in the fixed contact bar 410. The gas generation arm 432 is supported by the second extension portion 412. Simultaneously, the gas generation arm 432 supports the second extension portion 412 from above.

Therefore, the coupled state between the gas generation member 430 and the fixed contact bar 410 may be stably maintained.

In addition, the fastening member 450 is coupled to the gas fastening hole 453 formed in the gas generation arm 432. The gas generation member 430 and the housing 500 may be stably coupled.

The arc runner 440 is coupled to the housing 500 in the state in which the gas generation member 430 is accommodated. In this case, the gas generation arm 432 is coupled to the housing 500 while covering the arc runner arm 444 from the outside. In other words, the gas generation arm 432 is disposed to face the housing 500 with the arc runner arm 444 interposed therebetween.

Therefore, the front side of the arc runner 440 is supported by the gas generation arm 432, and the rear side of the arc runner 440 is supported by the contact housing body 510. Therefore, the arc runner 440 does not separate from the front or rear side.

The second arc runner body 442 is seated on the arc runner support portion 413 of the fixed contact bar 410. The second arc runner body 442 is supported by the arc runner support portion 413. Simultaneously, the second arc runner body 442 supports the second extension portion 412 from above.

The arc runner arm 444 is accommodated in the arc runner accommodation groove 417. The arc runner arm 444 is supported by the second extension portion 412. Simultaneously, the arc runner arm 444 supports the second extension portion 412 from above or in the width direction, i.e., from the left and right sides.

Therefore, the coupled state between the arc runner 440 and the fixed contact bar 410 may be stably maintained.

In addition, the fastening members 450 are coupled to the arc fastening holes 447 respectively formed in the third arc runner body 443 and the arc runner arm 444. Therefore, the coupled state between the arc runner 440 and the housing 500 may be stably maintained.

That is, the components of the fixed contact part 400 may be coupled to the housing 500 simply by the fastening members 450. Simultaneously, the components of the fixed contact part 400 are coupled to support one another, such that the coupled state of the fixed contact part 400 and the coupled state between the fixed contact part 400 and the housing 500 may be stably maintained.

While the embodiments of the present disclosure have been described, the spirit of the present disclosure is not limited to the embodiments presented in the present specification, those skilled in the art, who understand the spirit of the present disclosure, may easily propose other embodiments by adding, changing, deleting constituent elements within the same spirit and scope of the present disclosure, and it can be said that the embodiments are also within the spirit and scope of the present disclosure.

| | |
|---|---|
| 10: Breaker | 100: Frame |
| 200: Arc Extinguishing Member | 200a: First Arc Extinguishing Member |
| 200b: Second Arc Extinguishing Member | 200c: Third Arc Extinguishing Member |
| 300: Conduction Part | 300a: First Conduction Part |
| 300b: Second Conduction Part | 300c: Third Conduction Part |
| 310: Terminal | 320: Movable Contact Part |
| 321: Movable Contact Bar | 322: Movable Contact |
| 400: Fixed Contact Part | 400a: First Fixed Contact Part |
| 400b: Second Fixed Contact Part | 400c: Third Fixed Contact Part |
| 410: Fixed Contact Bar | 411: First Extension Portion |
| 412: Second Extension Portion | 413: Arc Runner Support Portion |
| 414: Restriction Protrusion | 415: Housing Accommodation Groove |
| 416: Gas Generation Member Accommodation Groove | 417: Arc Runner Accommodation Groove |
| 420: Fixed Contact | 430: Gas Generation Member |
| 431: Gas Generation Body | 432: Gas Generation Arm |
| 433: Arc Runner Accommodation Space | 434: Arc Runner Accommodation Groove |
| 435: Gas Fastening Hole | 440: Arc Runner |
| 441: First Arc Runner Body | 442: Second Arc Runner Body |
| 443: Third Arc Runner Body | 444: Arc Runner Arm |
| 445: Cut-Out Groove | 446: Accommodation Space |
| 447: Arc Fastening Hole | 448: Contact Bar Accommodation Space |
| 450: Fastening Member | 500: Housing |
| 510: Contact Housing Body | 511: Outer Wall |
| 512: Inner Wall | 520: Terminal Coupling Portion |
| 520a: First Terminal Coupling Portion | 520b: Second Terminal Coupling Portion |
| 520c: Third Terminal Coupling Portion | 521: Terminal Accommodation Space |
| 522: Terminal Through-Hole | 530: Contact Bar Coupling Portion |
| 530a: First Contact Bar Coupling Portion | 530b: Second Contact Bar Coupling Portion |
| 530c: Third Contact Bar Coupling Portion | 531: Contact Bar Accommodation Space |
| 532: Contact Bar Through-Hole | 540: Housing Fastening Hole |
| 1000: Breaker in related art | 1100: Terminal |
| 1110: Inner Terminal | 1111: Runner Accommodation Groove |
| 1120: Outer Terminal | 1200: Arc Runner |
| 1210: Terminal Coupling End | |

1. A fixed contact part comprising:
a fixed contact bar conductively connected to an external power source or an external load;
a fixed contact coupled to the fixed contact bar and configured to come into contact with a movable contact; and
an arc runner positioned at one side of the fixed contact bar based on a height direction and configured to guide a generated arc,
wherein the fixed contact bar comprises:
a first extension portion extending in one direction; and
a second extension portion continuously connected to the first extension portion while having a predetermined angle with respect to the first extension portion, and
wherein the arc runner is seated and supported on the second extension portion.

2. The fixed contact part of claim 1, wherein the fixed contact bar comprises an arc runner support portion protruding from one end directed toward the arc runner, among ends of the second extension portion, and configured to support the arc runner.

3. The fixed contact part of claim 1, comprising:
a gas generation member configured to generate gas while chemically reacting with heat,
wherein the gas generation member is accommodated in the arc runner and supported by the arc runner.

4. The fixed contact part of claim 3, wherein the gas generation member comprises:
a gas generation body accommodated in the arc runner; and
a gas generation arm extending from one end directed toward the fixed contact bar, among ends of the gas generation body, and configured to surround the second extension portion, and
wherein the fixed contact bar comprises a gas generation member accommodation groove recessed at one end directed toward the gas generation member, among ends of the second extension portion, and configured to at least partially accommodate the gas generation arm.

5. The fixed contact part of claim 4, wherein the gas generation member accommodation groove is recessed at an edge of one end of the second extension portion.

6. The fixed contact part of claim 1, comprising:
a gas generation member configured to generate gas while chemically reacting with heat, accommodated in the arc runner, and supported by the arc runner,
wherein the arc runner comprises:
an arc runner body disposed to overlap the gas generation member; and
an arc runner arm extending from one end directed toward the fixed contact bar, among ends of the arc runner body, and configured to surround the second extension portion, and
wherein the fixed contact bar comprises an arc runner accommodation groove recessed at one end directed toward the arc runner, among ends of the second extension portion, and configured to at least partially accommodate the arc runner arm.

7. The fixed contact part of claim 6, wherein the arc runner accommodation groove is recessed at an edge of one end of the second extension portion.

8. The fixed contact part of claim 6, wherein the gas generation member comprises:
a gas generation body accommodated in the arc runner; and
a gas generation arm extending from one end directed toward the fixed contact bar, among ends of the gas generation body, and configured to surround the second extension portion, and
wherein the fixed contact bar comprises a gas generation member accommodation groove recessed at one end of the second extension portion and configured to at least partially accommodate the gas generation arm and communicate with the arc runner accommodation groove.

9. The fixed contact part of claim 1, wherein the arc runner comprises:
a first arc runner body extending in a height direction of the fixed contact bar;
a second arc runner body extending in one direction while having a predetermined angle with respect to the first arc runner body;
a third arc runner body extending in the height direction of the fixed contact bar while having a predetermined angle with respect to the second arc runner body and configured to face the first arc runner body; and
an accommodation space formed by being surrounded by the first arc runner body, the second arc runner body, and the third arc runner body.

10. The fixed contact part of claim 9, wherein the third arc runner body extends to be inclined in a direction toward the first arc runner body.

11. The fixed contact part of claim 9, comprising:
a gas generation member configured to generate gas while chemically reacting with heat, accommodated in the arc runner, and supported by the arc runner, wherein the gas generation member comprises:
a gas generation body formed to have a width larger than a length of the second arc runner body and accommodated in the accommodation space; and
a gas generation arm extending from one end directed toward the fixed contact bar, among ends of the gas generation body, and configured to surround the second arc runner body in a width direction.

12. The fixed contact part of claim 11, wherein the gas generation member comprises an arc runner accommodation groove recessed in one surface directed toward the third arc runner body, among surfaces of the gas generation body, and configured to accommodate the third arc runner body.

13. A breaker comprising:
a frame in which a space is formed;
a housing coupled to the frame while covering the space; and
a fixed contact part accommodated in the space, coupled to the housing, partially exposed to the outside, and conductively connected to an external power source or an external load,
wherein the fixed contact part comprises:
a fixed contact bar configured to penetrate the housing and partially exposed to the outside; and
an arc runner positioned above the fixed contact bar and configured to guide a generated arc to the outside, and
wherein the housing comprises:
a contact bar accommodation space recessed in one surface directed toward the frame and configured to accommodate a partial portion of the fixed contact bar and the arc runner; and
a contact bar through-hole formed through the inside of the contact bar accommodation space and coupled to the fixed contact bar.

14. The breaker of claim 13, wherein the fixed contact bar comprises:
a first extension portion extending in one direction, configured to penetrate the contact bar through-hole, and partially exposed to the outside; and
a second extension portion positioned in the contact bar accommodation space and extending in a direction opposite to the arc runner while having a predetermined angle with respect to the first extension portion, and
wherein the arc runner partially surrounds the second extension portion.

15. The breaker of claim 14, wherein the arc runner comprises:
a first arc runner body provided to be in contact with one surface of the housing and extending in the other direction;
a second arc runner body extending in a direction toward the frame while having a predetermined angle with respect to the first arc runner body;
a third arc runner body extending in the other direction while having a predetermined angle with respect to the second arc runner body and configured such that an end of the third arc runner body based on the extension direction is coupled to one surface of the housing; and
an accommodation space formed by being surrounded by the first arc runner body, the second arc runner body, and the third arc runner body.

16. The breaker of claim 15, comprising:
a gas generation member positioned above the fixed contact bar, coupled to the housing, and configured to generate gas while chemically reacting with heat generated together with the arc,
wherein the gas generation member comprises:
a gas generation body accommodated in the accommodation space; and
a pair of gas generation arms extending from a lower end of the gas generation body and configured to surround the second extension portion and the second arc runner body in a width direction.

17. The breaker of claim 14, wherein the fixed contact bar comprises an arc runner support portion protruding from an upper end of the second extension portion,
wherein the arc runner support portion is in contact with a partial portion of the housing that surrounds the contact bar through-hole from above, and
wherein the second extension portion is in contact with another portion of the housing that surrounds the contact bar through-hole from below.

18. The breaker of claim 14, wherein the fixed contact bar comprises housing accommodation grooves recessed inward at a pair of edges positioned above the first extension portion, the housing accommodation grooves being configured to accommodate a partial portion of the housing, and
wherein the partial portion of the housing accommodated in the housing accommodation grooves is configured to support the first extension portion.

19. The breaker of claim 14, comprising:
a gas generation member positioned above the fixed contact bar, coupled to the housing, and configured to generate gas while chemically reacting with heat generated together with the arc,
wherein the arc runner comprises arc runner arms extending downward, spaced apart from each other in a width direction, and configured to surround the second extension portion in the width direction, and
wherein the gas generation member comprises gas generation arms extending downward, spaced apart from each other in a width direction, configured to surround the second extension portion in the width direction, and disposed to overlap the arc runner arms so as to face the housing with the arc runner arms interposed therebetween.

20. The breaker of claim 19, wherein the fixed contact bar comprises:
an arc runner accommodation groove recessed at an upper edge of the second extension portion and configured to accommodate the arc runner arm; and
a gas generation member accommodation groove positioned to be closer to the space of the frame than the arc runner accommodation groove, recessed at the upper edge of the second extension portion, and configured to accommodate the gas generation arm and communicate with the arc runner accommodation groove.
